(19) United States
(12) Patent Application Publication
(10) Pub. No.: US 2026/0252317 A1
(43) Pub. Date: Aug. 27, 2026

(54) AUTOMATED CODE GENERATION AND REVISION FOR COMPUTING SYSTEMS AND APPLICATIONS

(71) Applicant: NVIDIA Corporation, Santa Clara, CA (US)

(72) Inventors: Avinash PATHAK, Pune (IN); Yogesh DANGI, Pune (IN); Manas Ranjan JAGADEV, San Jose, CA (US)

(21) Appl. No.: 19/064,265

(22) Filed: Feb. 26, 2025

(51) Int. Cl. G06F 8/30

(52) U.S. Cl. CPC G06F 8/30

(57) ABSTRACT

Embodiments of the present disclosure relate to automated computer programming code generation and revision. A language model agent first provides input to a first language model such that the first language model generates computer programming code based at least on the input. Responsively, some embodiments then automatically provide the computer programming code to a first code evaluation tool such that the first code evaluation tool generates feedback. Responsively, some embodiments automatically provide, back to the first language model, one or more prompts that requests the first language model to re-generate or revise the computer programming code based at least on the original input and the feedback until the re-generated code meets a code quality threshold(s), at which point a second language model may be used for a final review of re-generated or revised computer programming code.

### BACKGROUND

Code assistance tool technologies, such as code editors, Integrated Development Environments (IDEs), or code completion tools, are software applications designed to help developers write, debug, and maintain code more efficiently. These tools provide features like syntax highlighting, code completion, error detection, and debugging support, which significantly reduce development time and minimize coding errors. However, the quality of assistance of these tools is often poor. Consequently, this leads to various technical problems such as increased coding errors and inefficiencies.

### SUMMARY

Embodiments of the present disclosure relate to automated computer programming code generation and revision. According to some embodiments, a language model agent (e.g., a ReAct LLM agent) first provides input (e.g., a user-defined code quality template) to a first language model (e.g., a generative language model, such as a large language model (LLM), vision language model (VLM), multi-modal language model (MMLM), and/or the like) such that the first language model generates computer programming code based at least on the input. In response to the first language model generating the computer programming code, some embodiments then automatically provide the computer programming code to a first code evaluation tool (e.g., a compiler) such that the first code evaluation tool generates feedback (e.g., a success/failure message with errors).

In response to the code evaluation tool generating feedback for the computer programming code, some embodiments automatically provide, back to the first language model, a prompt that requests the first language model to re-generate or revise the computer programming code based at least on the original input and the feedback. In response to such functionality, some embodiments then determine whether the re-generated code meets a code quality threshold(s) (e.g., based on the code quality template defined by a user). For example, a user may have defined, as part of a code quality template, that the code must handle exceptions properly, especially file handling errors like file not found, and must not catch overly broad exceptions. However, the code evaluation tool may determine that the code handles errors but does so in a way that catches all exceptions generically without providing specific handling. In this example, the code quality threshold or standards are not met because the code fails due to overly broad exception handling.

In response to the determining that the re-generated code does not meet the code quality threshold(s), some embodiments continuously cause the first language model to re-generate code until the code quality threshold(s) is met. In other words, when embodiments determine that the re-generated code does not meet the code quality threshold(s), it triggers an iterative improvement loop that continuously engages the first language model to refine the code based on the feedback received from the code evaluation tool. The language model agent provides the first language model with specific feedback about why the code did not meet the quality standards, prompting the model to make targeted adjustments. This process repeats until the code meets the defined quality threshold(s).

Based at least on the code quality threshold(s) being met, some embodiments automatically provide, to a second language model (e.g., an LLM, VLM, MMLM, and/or the like), finalized computer programming code and a request to perform a final evaluation of the finalized computer programming code. This process relates to a “peer review” or “final code review” operation, where a second language model (e.g., with a different architecture, training process, fine-tuning process, retrieval augmented generation (RAG) system, and/or other difference(s) relative to the first language model) is used to independently assess the code. At least one purpose of using a second model, such as one distinct from the first model that generated the code, is to mitigate potential biases introduced by the first model during the iterative refinement process. This independent evaluation helps ensure that the code meets standards of quality, correctness, and/or security, providing an unbiased assessment that confirms the computer programming code's readiness for deployment. By involving a different model, the system adds a layer of scrutiny, enhancing the overall reliability and objectivity of the code review process.

### BRIEF DESCRIPTION OF THE DRAWINGS

The present systems and methods are described in detail below with reference to the attached drawing figures, wherein:

FIG. 1 is a block diagram of an example system architecture, in accordance with some embodiments;

FIG. 2 is a block diagram of an example pipeline for generating and revising computer program code, according to some embodiments;

FIG. 3 is a block diagram of a system illustrating how an LLM agent communicates with various components to generate and revise computer programming code, according to some embodiments;

FIG. 4 is a screenshot of an example user interface page illustrating how computer programming code is generated and revised, according to some embodiments;

FIG. 5 is a flow diagram of an example process for generating and revising computer program code, according to some embodiments;

FIG. 6 is a flow diagram of an example process for re-generating or revising computer programming code, according to some embodiments;

FIG. 7 is a flow diagram of an example process for tuning a language model agent to generate a prompt, according to some embodiments;

FIG. 8 is a flow diagram of an example process for tuning a language model to generate computer programming code, according to some embodiments;

FIG. 9 is a block diagram of an example architecture that illustrates where LLM agents and LLMs may be hosted, according to some embodiments;

FIG. 10A is a block diagram of an example generative language model system suitable for use in implementing at least some embodiments of the present disclosure;

FIG. 10B is a block diagram of an example generative language model that includes a transformer encoder-decoder suitable for use in implementing at least some embodiments of the present disclosure;

FIG. 10C is a block diagram of an example generative language model that includes a decoder-only transformer architecture suitable for use in implementing at least some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

As described above, the quality of assistance from code assistance tools can be poor due to several factors, leading to potential technical problems like increased errors and inefficiencies. For example, one technical issue is that language models (e.g., LLMs, VLMs, MMLMs, etc.) hallucinate when generating code due to their lack of true understanding of programming logic and context, relying instead on pattern recognition from training data. Language models, including those used for code generation, are trained on large datasets of text and code, learning to predict the next token (word, symbol, or character) based on the context of previous tokens. They do not understand the semantics of the code, the problem domain, or the intention behind the code. As a result, they can generate plausible-looking but incorrect or nonsensical code because they rely on patterns without true comprehension of programming logic or requirements. The models often overgeneralize patterns from diverse and sometimes erroneous data, propagating early mistakes throughout the code generation process. Without built-in validation mechanisms, they generate code that may reference non-existent functions, incorrect API calls, or unsupported features. This bias toward plausibility over accuracy can result in subtle bugs, increased debugging time, and misleading outputs that compromise software quality.

Because of such hallucination or low quality code generation, existing coding assistance tools also often require significant manual interaction from users. Users must frequently intervene to provide detailed prompts, adjust settings, specify corrections, and manually integrate feedback from various tools like linters and security analyzers. This process involves iteratively refining the code by constantly guiding the LLM and other evaluation tools, leading to a time-consuming cycle of trial and error. The reliance on such manual input not only slows down development but also shifts the burden of quality assurance onto the user and is associated with increased input/output (I/O), leading to unnecessary wear and tear on storage devices (e.g., disk) because there is a significant quantity of manual inputs needed by users to fix coding problems.

Additionally, many code assistance tools struggle with understanding complex or less common programming patterns, leading to suggestions that do not align with best practices or the intended functionality. For example, automated code generation might overlook important security considerations, such as input validation or secure coding standards, inadvertently introducing vulnerabilities into the code base.

Many code assistance tools additionally suffer from runtime inefficiencies because they often generate suggestions or code snippets that are not optimized for performance. For example, they may suggest less efficient algorithms, redundant computations, or unnecessary memory usage, leading to slower execution times, increased resource consumption, or scalability issues. These runtime inefficiencies can have a significant impact, especially in performance-critical applications where optimized code is essential.

Beyond runtime, inefficiencies include the additional time and effort required by developers to correct or refactor the code generated by these tools. Poor suggestions can lead developers down unproductive paths, requiring more debugging, rewriting, or re-architecting of code. This can slow down the development process, extend project timelines, and increase the overall workload.

Various embodiments of the present disclosure help remedy one or more of these technical deficiencies (and/or other technical deficiencies) of these coding assistance tools described above. Particular embodiments are directed to automatically reviewing and revising language-model-generated code based on defined quality standards and the usage of separate code evaluation tools. In operation, some embodiments first provide input to a first language model (e.g., an LLM, VLM, MMLM, etc.) such that the first language model generates computer programming code based at least on the input. For example, an LLM agent (e.g., a ReAct LLM agent) first receives the input, where the input includes a problem statement indicative of a problem or task that a user wants to solved or addressed, a code quality template indicating how generated code should be structured, written, or behave, or a list of code evaluation tools to be used for the feedback including the first code evaluation tool.

In response to the first language model generating the computer programming code, some embodiments then automatically provide the computer programming code to a first code evaluation tool such that the first code evaluation tool generates feedback for the computer programming code. For example, the LLM agent may pass the computer programming code to a code evaluation tool, such as a compiler. In this example, the compiler will compile the computer programming code and return the success/failure message along with errors if any, all of which represents the feedback.

In response to the code evaluation tool generating feedback for the computer programming code, some embodiments automatically provide, to the first language model, a prompt that requests the first language model to re-generate computer programming code based at least on the input and the feedback. For example, the user may initially request the model to generate Python code that reads a file and prints its contents (e.g., as specified in the input to the first language model). The compiler attempts to run the code and returns a failure message indicating a syntax error, “SyntaxError: unexpected EOF while parsing.” The feedback from the compiler is provided as, for example, “The code failed to compile with the error message ‘SyntaxError: unexpected EOF while parsing.’ This error suggests that there is an incomplete line or a missing closing bracket, quotation mark, or parenthesis.” The prompt described above may be an LLM prompt that states, “The previous attempt to generate code to read a file and print its contents resulted in a compilation error. The compiler returned the following feedback: ‘SyntaxError: unexpected EOF while parsing.’ This error indicates that the code has a missing or incomplete line, such as a missing closing bracket, quotation mark, or parenthesis. Based on this feedback, regenerate the code to read a file and print its contents, ensuring that the syntax is correct and the code can compile successfully. Please fix any syntax issues identified by the compiler and ensure the code handles file reading properly.”

The prompt communicates the specific error message from the compiler and provides a brief interpretation of what might have caused the issue. The prompt instructs the first language model to regenerate the code by correcting the syntax errors identified by the compiler, while still aligning with the initial goal of reading and printing the file contents. This approach directs the model to consider both the original input task and the feedback, ensuring the regenerated code addresses the errors without deviating from the intended functionality.

Accordingly, the first language model outputs re-generated code based at least on the prompt. In response to such functionality, some embodiments determine whether the re-generated code meets a code quality threshold (e.g., based on code quality standards defined by a user). For example, a user may have defined, as part of the input, that the code must handle exceptions properly, especially file handling errors like file not found, and must not catch overly broad exceptions. However, a code quality checker may determine that the code handles errors but does so in a way that catches all exceptions generically without providing specific handling for file-related errors like “FileNotFoundError.” In this example, the code quality threshold or standards are not met because the code fails due to overly broad exception handling.

In response to the determining that the re-generated code does not meet the code quality threshold, some embodiments continuously cause the first language model to re-generate code until the code quality threshold is met. In other words, when the system determines that the re-generated code does not meet the code quality threshold, it triggers an iterative improvement loop that continuously engages the first language model to refine the code based on the feedback received. The system provides the first language model with specific feedback about why the code did not meet the quality standards, prompting the model to make targeted adjustments. This process repeats until the code meets all defined quality thresholds. For example, with respect to the exception handling error example above, some embodiments send this feedback back to the first language model with a prompt, “The current code catches all exceptions generically with ‘except Exception’, which does not meet the code quality standards. Please refine the code to specifically handle file-related exceptions, such as ‘FileNotFoundError’, and ensure that other errors are managed appropriately.” The language model then generates new code, adjusting the exception handling as instructed. This new code is then re-evaluated by the code evaluation tool. If the updated code still does not meet the quality threshold, the system continues the loop, refining the prompt based on the latest feedback, until the code adheres to the standard.

Based at least on the code quality threshold being met, some embodiments automatically provide, to a second language model (e.g., LLM, VLM, MMLM, etc.), finalized computer programming code and a request to perform a final evaluation of the finalized computer programming code. This process relates directly to a “peer review” or “final code review” step, where a second language model (e.g., with a different architecture relative to the first language model) is used to independently assess the code. At least one purpose of using a second model, such as one distinct from the initial model that generated the code, is to mitigate potential biases introduced by the first model during the iterative refinement process. This independent evaluation helps ensure that the code meets broader standards of quality, correctness, and/or security, providing an unbiased assessment that confirms the code's readiness for deployment. By involving a different model, the system adds a layer of scrutiny, enhancing the overall reliability and objectivity of the code review process. For example, after meeting the code quality threshold, some embodiments send the code to a second language model with a prompt, such as “The following code has been refined to meet defined quality standards. Please perform a final evaluation to ensure it handles all exceptions properly, is optimized, and meets best practices. Provide feedback if any further adjustments are needed.” The second model evaluates the code, ensuring that it aligns with standards without relying on the biases or blind spots of the first model, offering an additional layer of validation before the code is finalized.

There are various technical effects, advantages and benefits relative to existing coding assistance tools. For example, some embodiments solve the language model hallucination problem by incorporating one or more code evaluation tools (e.g., compilers or code compliance tools). Unlike existing language models, various code evaluation tools do understand the semantics of the code, the problem domain, or the intention behind the code. As a result, even if a language model initially hallucinates, the feedback provided by a code evaluation tool allows the model to revise its code so that hallucination is corrected. These tools have true comprehension of programming logic or requirements. Therefore, embodiments are less likely to reference non-existent functions, incorrect API calls, or unsupported features. This can reduce bugs, debugging time, and increase coding accuracy.

Additionally, various embodiments automate the coding assistance pipeline, such as by automatically generating and re-generating/refining computer programming code using language models, language model agents, and/or coding evaluation tools. This reduces the requirement of significant manual interaction from users. The reduction of such manual input not only speeds up development but also reduces computer I/O, leading to reduced wear and tear on storage devices (e.g., disk). This is because there is a significant reduction in the quantity of manual input needed by users to fix coding issues. For example, instead of requiring a user to input a long prompt, followed by manually copying code an incorporating it into a coding assistance tool, and then manually generating, checking, and refining code themselves (e.g., multiple I/Os), a user may only have to provide a single input (e.g., inputting a code quality template) corresponding to a single I/O to generate and re-generate/refine the code without any other user input due to the automated communication between the language model, the language model agent, and/or the coding evaluation tools. This helps language models to improve the code quality in a much smaller quantity of iterations relative to error prone human feedback.

Various embodiments are also efficient, both at runtime and development time, relative to existing technologies. This is because some embodiments use multiple code evaluation tools (e.g., a compiler and a code compliance tool) all in one pipeline. For example, users can specify, at the input, various code evaluation tools and/or various code quality standards (e.g., no memory leaks, error handling, and no security vulnerabilities). In this way, particular embodiments generate code snippets that are optimized for performance, such as efficient algorithms, less redundant computations, or efficient memory usage, leading to faster execution times, reduced resource consumption, or scalability efficiencies. These optimized suggestions lead to less debugging, rewriting, or re-architecting of code. This speeds up the development process, reduces project timelines, and reduces the overall workload. This is because multiple different code evaluation tools can be used at one time or in a single pipeline.

In some embodiments, the systems and methods described herein may be performed within (or used to programmatically build) a simulation environment (e.g., NVIDIA's DriveSIM) using simulated data (e.g., simulated sensor data of simulated sensors of a virtual or simulated machine). For example, computer programming code may be generated and refined, which represents simulated sensor data and/or map data to be used to identify regions of interest and sub-regions of interest within the simulation environment. This information may be used to perform operations associated with the virtual machine within the environment. These simulated operations may be used to test performance of the underlying algorithms, code, systems, and/or processes prior to deploying them in the real-world. In some instances, the simulation may be used to generate synthetic training data. The synthetic training data (in addition to or alternatively from real-world data) may then be processed to determine geometry and/or other information related to regions of interest. In any example, such as where a simulation environment is used for testing, validation, training, etc., the simulation environment and/or associated training data may be rendered or otherwise generated using computer programming code that indicates one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems such as systems for testing, validating, training (e.g., machine learning models, neural networks, etc.), and/or other tasks related to automotive, robot, machine, or other applications.

It is understood that the code being generated or checked may be used for various other processes and technologies, as described below. The code execution in each case and the feedback may be generated or checked directly in the particular environment (e.g., talking or smart kiosk application, auto, gaming, robotics, video conferencing, in-vehicle infotainment (IVI) system or in-cabin experience (IX) application, etc.). For example, the system and methods described herein may be deployed in a talking or smart kiosk application. For instance, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs—such as, without limitation, REST APIs.

In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers).

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In some embodiments, one or more transformer engines (TEs) may be implemented. The transformer engine may use micro-tensor scaling to optimize performance and accuracy—such as to enable 16-bit floating point (FP16), 8-bit floting point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using switches—such as NVLink Switches) and tensor cores (which enable mixed-precision computing, such as microscaling precision support), server clusters may be more capable of training enormous networks (e.g., billions of parameters) at high speeds. As such, tensor core precisions of FP64, TF32, BF16, FP16, FP8, INT8, FP6, and FP4 may be supported, as well as CUDA core precisions of FP64, FP32, FP16, and BF16.

### Example System Architecture

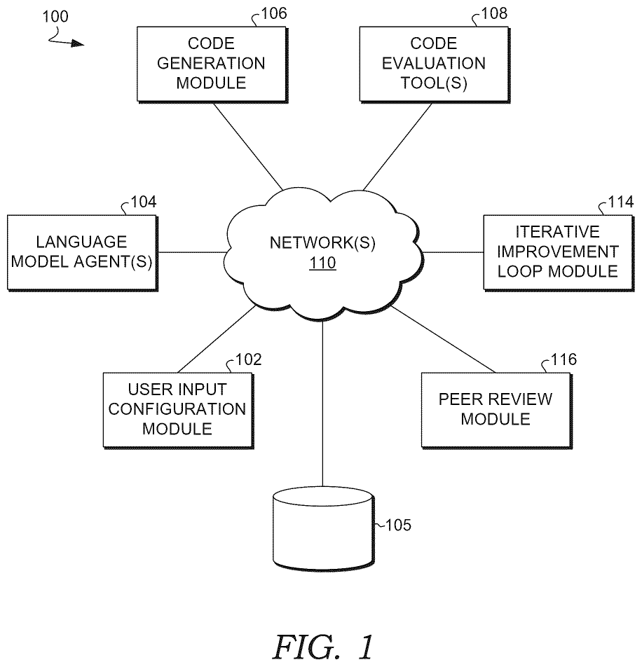

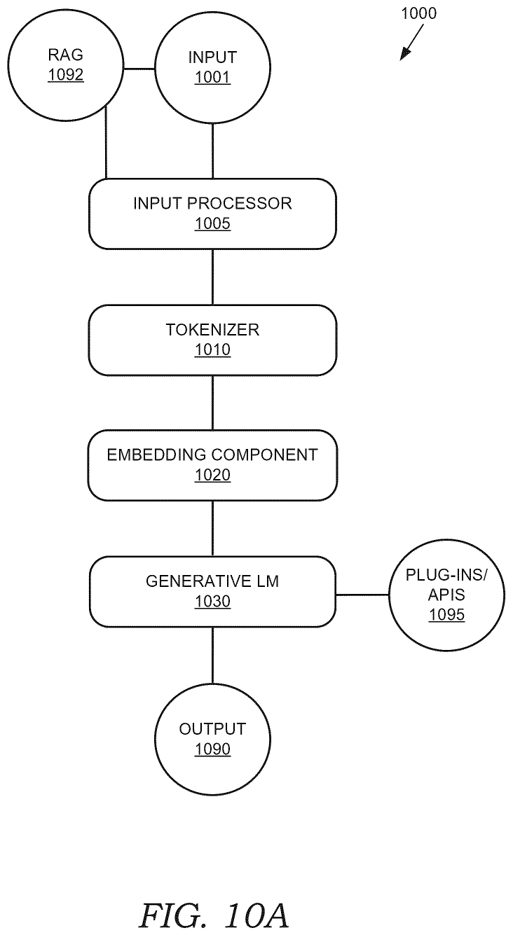

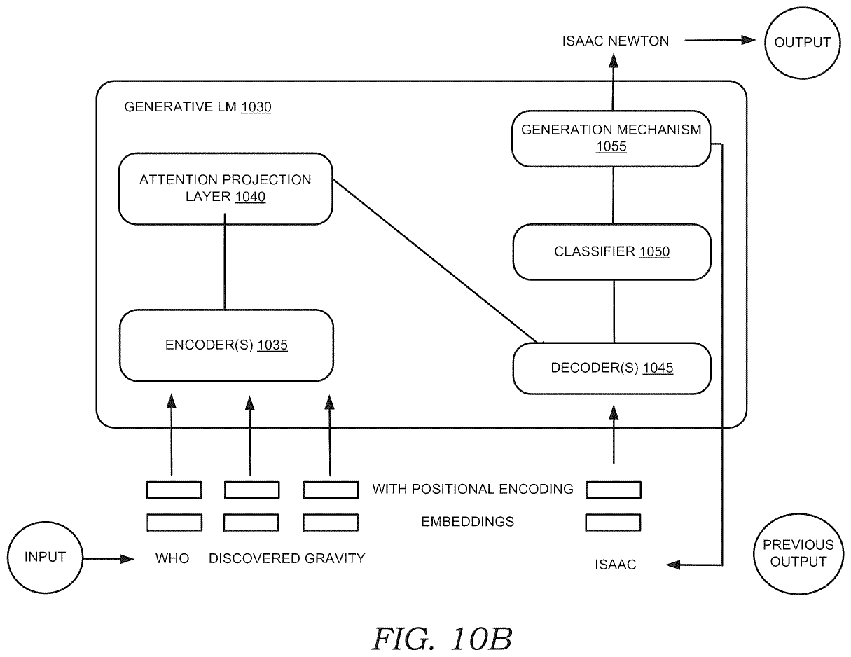

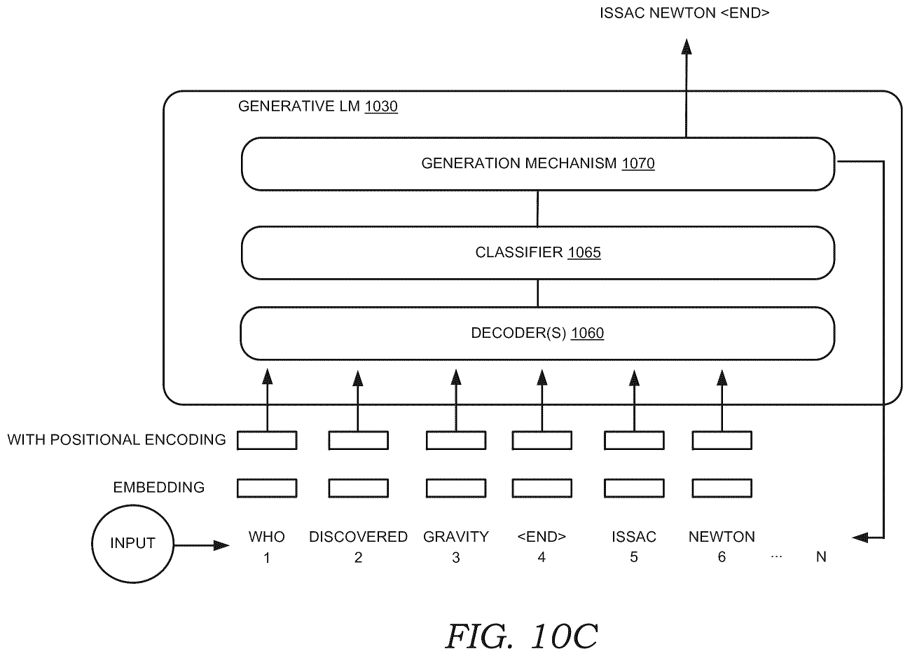

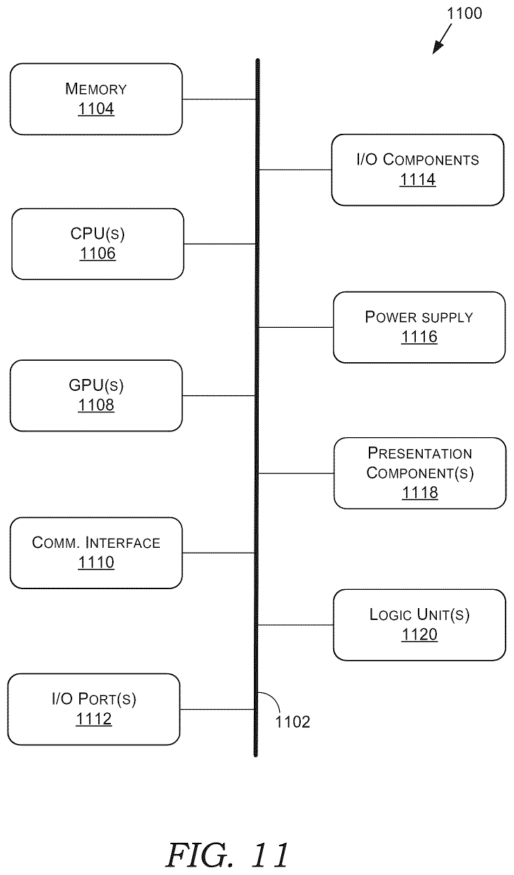

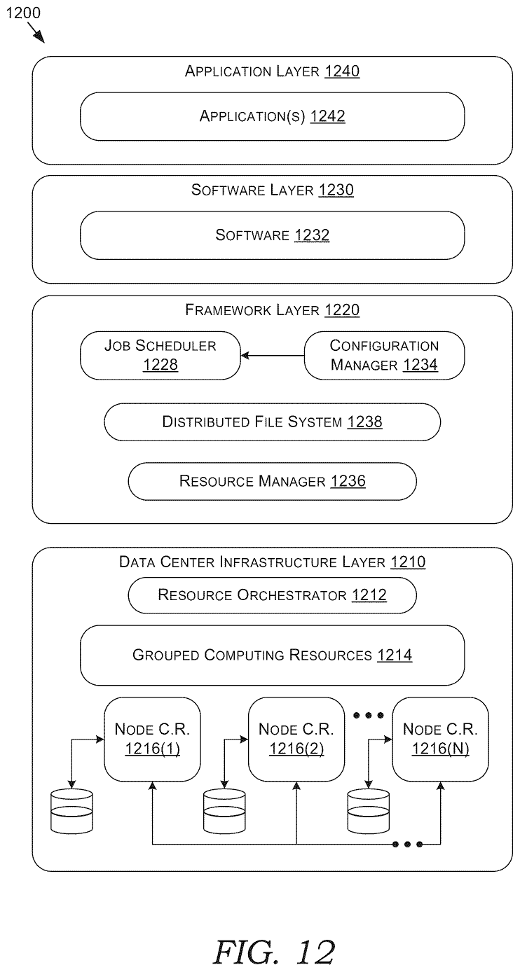

With reference to FIG. 1, FIG. 1 is a block diagram of an example system architecture (referred to as “system 100”), in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example generative models/systems of FIG. 10A through 10C, the computing device of FIG. 11, and/or data center of FIG. 12.

In the embodiment illustrated in FIG. 1, the system 100 includes a user input configuration module 102, a language model agent(s) 104, a code generation module 106, a code evaluation tool(s) 108, an iterative improvement loop module 114, a peer review module 116, and storage 105, each of which is communicatively coupled via one or more networks 110 (e.g., a Wide Area Network (WAN), a Local Area Network (LAN), a Service Network, or an Applicant Layer Network). The system 100 is generally responsible for the generation and re-generation/refinement of computer programming code using multiple tools. The storage 105 represents any suitable storage to store data (e.g., user input, prompts, code, cod evaluation tools, models, etc.), such as disk, RAM, a database, a Storage Area Network (SAN), RAID, or the like.

The user input configuration module 102 is responsible for receiving and processing user input to initiate the code generation process and/or configure setting(s) for the code generation process. The user input triggers the entire workflow, sending the user input to the language model agent 104 to begin the process. For example, the user input configuration module 102 receives a problem statement or query from the user, which is then passed to the language model agent 104. A “problem statement” is a description of a programming task or challenge that needs to be solved through code. It defines the goal of the coding effort by specifying what the program or algorithm should accomplish, outlining the inputs, expected outputs, constraints, and any specific conditions or requirements that need to be met. A problem statement provides the context for developers or coding systems, such as LLMs, to understand the exact task at hand and guide the development process towards a solution. For example, a problem statement may be in the form of a prompt that says, “Write a Python function that takes a list of integers as input and returns the list sorted in ascending order. The function should handle empty lists and should not use any built-in sorting functions.” In some embodiments, a problem statement is more generic, such as “write code for displaying this text X&$@ on a user interface screen.”

In some embodiments, the user input configuration module 102 additionally or alternatively receives a code quality template indicating how generated code should be structured, written, and/or behave. A code quality template is a set of predefined guidelines, rules, and/or standards provided by the user to ensure that the generated code meets specific quality expectations. These templates help maintain consistency, readability, security, and/or performance across codebases by enforcing best practices and coding standards. For example, a code quality template name may be “Python Web Application Standards.” This template outlines specific quality requirements for Python code used in web applications, focusing on readability, error handling, performance, security, and maintainability. For instance, there may be formatting and style standards, such as a requirement to adhere to PEP 8 coding style guidelines. For example, a user may provide input, “ensure proper indentation (4 spaces per level), use snake_case for variable and function names, and limit line length to 79 characters.” With respect to error handling, the user may specify to use specific exception handling rather than catching generic exceptions. In another example, with respect to security practices, there may be a requirement to validate all inputs and sanitize user data to prevent SQL injection and XSS attacks. The user may indicate, for example, to “use parameterized queries to avoid SQL injection” and “escape user inputs when rendering data in HTML.”

Additionally or alternatively, the user input configuration module 102 receives, from a user device, a list of code evaluation tools to be used for the feedback provided by the code evaluation tool(s) 108. When a user provides a list of code evaluation tools to be used for feedback, they specify which tools the system should employ to assess the generated code's quality, correctness, security, and/or other relevant attributes. This list helps tailor the evaluation process (by the code evaluation tool(s) 108) to the user's specific needs, ensuring that the feedback generated is comprehensive and aligned with the desired standards. For example, the user may have a JavaScript Web Application project that he is engaging in. The user's list of code evaluation tools may be as follows: ESLint (for linting JavaScript code, ensuring style consistency, and catching syntax errors), Mocha/Chai (for testing JavaScript functions to verify correct behavior and identify edge case issues), OWASP ZAP (for conducting security scans, identifying vulnerabilities like XSS (Cross-Site Scripting) or SQL Injection), and Lighthouse (for performance evaluation, ensuring that the web application meets performance benchmarks for speed and responsiveness).

The language model agent(s) 104 is generally responsible for orchestrating the entire workflow of code generation, evaluation, and refinement within the system 100. It acts as the central decision-making component, directing the code generation module 106 (e.g., a large language model (LLM)) to generate code based on the user's inputs, integrating feedback from various code evaluation tool(s) 108, and determining the necessary adjustments to improve the code. The language model gent manages the iterative loop of refining code by analyzing feedback, deciding on the next steps, and re-engaging the code generation module 106 to address identified issues. Its primary role is to ensure that the generated code evolves through multiple iterations to meet the defined quality standards, automating much of the reasoning and action required to produce high-quality code.

In some embodiments, the language model agent(s) 104 represents one or more LLM agents, such as a Reason and Action (ReAct) LLM Agent. A ReAct LLM agent is an advanced framework that combines reasoning capabilities with actionable steps, leveraging Large Language Models (LLMs) to perform complex tasks dynamically. This approach integrates the LLM's ability to understand, plan, and make decisions (reasoning) with its capability to execute specific actions based on those decisions (acting). The ReAct framework allows the agent to interact with external tools (e.g., the code evaluation tool(s) 108), refine its outputs iteratively, and adjust its behavior in real time, creating a cohesive system that can handle both cognitive and procedural aspects of task execution.

With respect to the “reasoning” phase, the ReAct agent uses the LLM's natural language understanding to analyze the problem (e.g., interpret user input received by the user input configuration module 102), interpret feedback (received from the code evaluation tool(s) 108), generate hypotheses, and plan next steps. This phase involves self-reflection, where the agent assesses its previous actions and determines what needs to be adjusted. With respect to the “action” phase, based on its reasoning, the agent performs specific actions such as generating code (via the code generation module 106), querying a database, calling external APIs, and/or interacting with other software tools. The actions are dynamically chosen and executed to move towards the desired goal, such as refining code based on feedback or solving a user-defined problem. The agent continuously evaluates the results of its actions by integrating feedback from evaluation tools (e.g., the code evaluation tool(s) 108) or environmental responses. If the outcome does not meet the required standards, the agent revisits the reasoning phase, modifies its approach, and takes further actions.

In an illustrative example, the ReAct LLM agent is tasked with generating Python code to read and process a file. The agent first understands (reasoning) the task and generates, via the code generation module 106, initial code based on the input description received by the user input configuration module 102. With respect to “action,” the ReAct LLM agent runs the code through a compiler (e.g., the code evaluator(s) 109) and identifies errors based on feedback, such as syntax mistakes or missing exception handling. The agent reasons about the feedback, determines the necessary corrections, and re-generates the code, continuously refining until it meets all quality standards. The ReAct LLM agent adapts its behavior based on real-time feedback, allowing for continuous improvement and alignment with defined goals. By combining reasoning and action, the agent automates code generation and refinement, reducing the need for constant human intervention.

The code generation module 106 is generally responsible for generating the computer programming code based on the user input provided by the user and the directives/instruction(s) given by the language model agent(s) 104. For example, the code generation module 106 may be an LLM (e.g., GPT-4), VLM, MMLM, etc. to generate the initial code based on the problem statement and parameters/code quality template defined by the user from the user input configuration module 102. In some embodiments, the initial output of the code generation module 106 is initial version of the code, which will then be passed back to the language model agent for further processing. In some embodiments, the language model agent(s) 104 may generate a prompts, which preprocesses or repackages the user input received by the configuration and user interaction module. In some embodiments, the code generation module 106 (and/or the peer review module 116) represents a generative language model/system, as described with respect to FIGS. 10A, 10B, and 10C.

In an illustrative example, the language model agent(s) 104 preprocesses the user input, which involves restructuring the user input into a format that clearly communicates the task requirements, standards, and constraints to the code generation module 106, ensuring that the generated code aligns with the user's expectations. By repackaging the input, the language model agent(s) 104 creates a precise and informative prompt that enhances the code generation module 106's understanding, leading to better, context-aware code generation. For example, the language model agent(s) 104 takes the initial user inputs, such as the problem statement and code quality templates, and synthesizes them into a cohesive, context-rich prompt. This process may involve summarizing the main objectives, highlighting key quality requirements, and specifying any constraints or conditions that must be met. The agent 104 reformulates the inputs into a structured prompt that includes clear instructions, relevant context, and specific criteria for the language model to consider during code generation or refinement. For example, the user input may be, “Create a Python script that reads data from a CSV file, processes the data to calculate the average value for each column, and prints the results,” and the code quality template may specify, “Adhere to PEP 8 style guidelines. Handle file-related errors specifically, such as FileNotFoundError. Include comments explaining the purpose of each major block of code. Ensure the code is optimized for performance, particularly when handling large files.” The language model agent(s) 104 may repackage such input by summarizing (based on its text summarization capabilities) this as, “Generate Python code based on the following requirements: 1. **Objective**: Create a script that reads data from a CSV file, processes the data to calculate the average value for each column, and prints the results. 2. **Code Quality Standards**:—Follow PEP 8 style guidelines for formatting and naming conventions.—Include specific error handling for file operations, such as catching ‘FileNotFoundError’.—Add comments that explain the purpose of each major block of code to improve readability and maintainability.—Ensure the code is optimized for handling large files efficiently to avoid performance bottlenecks. Make sure the generated code meets these quality standards and properly handles exceptions as described.”

In other words, the language model agent(s) 104 takes the raw user inputs and repackages them into a structured prompt that clearly outlines the task and quality expectations. This preprocessing ensures that the code generation module 106 understands not just what the code should do but also how it should be written, according to the user-defined standards/code quality templates. This approach minimizes ambiguity, providing, for example, a language model with a precise roadmap for generating high-quality code that meets both functional and stylistic criteria. By generating such prompts, the language model agent(s) 104 enhances the language model's ability to produce code that aligns closely with the user's needs, reducing the need for extensive manual adjustments later in the process.

The code evaluation tool(s) 108 is generally responsible for evaluating the generated code against predefined quality standards that are defined by the respective code evaluation tool and generating responsive feedback. For example, a compiler tool checks code for successful compilation and identifies syntax errors (the feedback), a memory leak checker: (Self-Reflection by LLM if no explicit tool is available), checks for memory leaks (the feedback), an error handling validator ensures that code includes proper error handling like try-catch blocks, and a security vulnerability checker evaluates the code for potential security risks.

If there are multiple code evaluation tool(s) 108 to choose from, the language model agent(s) 104 instruct specific code evaluation tool(s) 108 to evaluate the generated code based on the user input. For example, an LLM Agent first parses and analyzes the user's input (e.g., via tokenization, Named Entity Recognition (NER), and/or other Natural Language Processing (NLP) capabilities), which includes the problem statement, code quality templates, and possibly a list of preferred or required evaluation tools. This input provides the context and criteria for the evaluation. The agent 104 maintains a mapping (e.g., a lookup data structure or key-value pair) of each evaluation tool's capabilities, such as which tools check for style, security, performance, or specific language support. The agent compares the user-defined requirements/input against this mapping (e.g., via semantic analysis) to determine which tools are most appropriate for the task. In some embodiments, the language model agent(s) 104 uses a selection algorithm that could be rule-based, heuristic-driven, or even powered by a decision tree or machine learning model to determine the most suitable evaluation tool based on tool compatibility (whether the tool supports the language and environment of the generated code), evaluation requirements (whether the tool addresses specific quality standards or constraints specified by the user (e.g., security checks, error handling), and/or priority and performance (considering factors like tool performance, evaluation speed, and the importance of specific feedback types).

Once the specific tool (e.g., code evaluation tool 108) is selected, the language model agent(s) 104 generates the appropriate command or API call to instruct the tool to evaluate the code. This may involve constructing a script, a command-line instruction, or a RESTful API request, depending on how the evaluation tool operates.

The “feedback” provided by the code evaluation tool(s) 108 may be any suitable feedback, including any suitable code analysis artifacts. For example, feedback may include syntax errors, which is feedback related to incorrect syntax in the code, such as missing semicolons, unmatched brackets, or invalid keywords, which is provided by compilers (e.g., GCC, Java Compiler), and interpreters (e.g., Python Interpreter). Feedback can also include code style and formatting issues. This represents feedback on how well the code adheres to style guidelines, such as indentation, naming conventions, and overall formatting. Linters (e.g., ESLint, Pylint, Checkstyle), for example, can give this kind of feedback. For example, such feedback may be “Line exceeds maximum length of 80 characters” or “Variable name does not conform to snake_case convention.”

Performance warnings are also a type of feedback. This is feedback related to performance inefficiencies, such as slow execution, high memory usage, or inefficient algorithms. Tools such as performance profilers (e.g., Valgrind, Intel VTune) and benchmarking tools can provide this feedback. For example, “Function processData( ) is taking longer than expected due to a nested loop with high time complexity.” Security vulnerabilities are also another form of feedback that can additionally or alternatively be used. The corresponding tools identify potential security issues in the code, such as SQL injection risks, cross-site scripting (XSS), insecure data handling, or use of outdated libraries. Security analysis tools (e.g., Fortify, Bandit, OWASP ZAP) may provide this feedback.

Other feedback additionally or alternatively includes the following, error handling and exception management (feedback on how well the code handles exceptions, such as missing try-catch blocks, catching overly broad exceptions, or failing to handle specific error scenarios), code smells and maintainability issues (highlights poor coding practices that can lead to maintainability problems, such as duplicated code, overly complex methods, or improper use of design patterns), static analyzers (e.g., SonarQube, PMD), “Method calculateDiscount( ) has high cyclomatic complexity. Consider refactoring to reduce complexity.”), memory leaks and resource management issues (feedback related to improper memory usage, such as leaks, uninitialized variables, or failure to release resources), unit test coverage and missing tests (feedback on the extent to which the code is covered by unit tests, identifying untested paths or missing test cases), dependency vulnerabilities and outdated libraries (identifies outdated, vulnerable, or incompatible dependencies used in the code, recommending updates or replacements), logic errors and incorrect outputs (identifies logical errors where the code does not produce the expected results due to incorrect algorithms or logic flaw, such as “test failed, expected output 42, but got null.”), concurrency and threading issues (feedback related to concurrency problems, such as race conditions, deadlocks, or improper synchronization), and/or security compliance and policy violations, such as “Code does not comply with GDPR requirements for data anonymization.”

In some embodiments, one of the code evaluation tool(s) 108 includes “self-reflection” functionality of the code generation module 106 and/or another language model. For example, if the user input specified to “check the code for memory leak,” most of the listed tools might not have the ability to explicitly check for memory leaks. In this case, an LLM or LLM agent can review the code itself (self-reflection) and generate feedback for itself. In another example, if the user input says, “write a code with exception handling, then in the first go, an LLM agent might not generate code with exception handling, but it can review it and improve code to have exception handling by trying to catch blocks.

After the code evaluation tool(s) 108 provide feedback, in some embodiments such feedback is passed back to the language model agent(s) 104 for further processing. For example, an LLM Agent gathers feedback from multiple evaluation tools (e.g., static analyzers, linters, performance profilers) after each evaluation cycle. The agent 104 interprets the feedback, categorizing issues by type (e.g., syntax errors, security vulnerabilities, performance warnings) and assesses the severity of each issue based on predefined criteria or user-defined quality standards/templates. The language model agent 104 synthesizes the feedback into a cohesive set of recommendations, prioritizing critical issues that need immediate attention (e.g., errors that prevent code execution or significant security flaws). Based on the feedback, the language model agent(s) 104 generates specific prompts or instructions for the code generation module 106 to refine (e.g., re-generate) the code, targeting the identified issues. The language model agent(s) 104 decides whether the code meets the quality thresholds (e.g., as described with respect to the iterative improvement loop module 114) or if further iterations are needed, continuously guiding the refinement loop until the code meets the required standards.

The iterative improvement loop module 114 is generally responsible for managing the process of continuously refining/re-generating code until it meets one or more code quality threshold(s) (e.g., as defined in quality templates and/or other user input set by the user). In some embodiments, such loop module 114 is included in the language model agent(s) 104 such that the language model agent(s) 104 is responsible for this functionality. This loop module 114 ensures that the system 100 repeatedly evaluates the code (via the code evaluation tool(s) 108), integrates feedback (via the language model agent(s) 104), and prompts the code generation module 106 to make necessary adjustments based on evaluation results. The Iterative Improvement Loop collects feedback from the code evaluation tool(s) 108 (e.g., linters, static analyzers, security scanners) based on the criteria outlined in the code quality templates and/or other user input. The loop module 114 analyzes the feedback, determines what adjustments are needed, and formulates specific instructions or prompts for the language model agent(s) 104 to act upon. For example, iterative improvement loop module 114 uses a combination of Natural Language Processing (NLP), rule-based systems, and/or machine learning algorithms to analyze feedback, determine necessary adjustments, and formulate specific instructions or prompts for the code generation module 106 to act upon. The loop module 114 generates refined prompts for the agent 104, guiding the next round of code generation. This can include instructions to fix identified errors, optimize performance, or enhance readability according to the quality templates. The loop module 114 communicates directly with the language model agent(s) 104, continuously managing the process until the code meets all quality thresholds. It ensures that the agent(s) 104 stays aligned with the refinement goals dictated by the quality templates and/or other user input.

In an illustrative example, the iterative improvement loop module 114 uses NLP to parse and interpret the textual feedback from various code evaluation tools. This involves extracting relevant information such as error messages, warnings, line numbers, severity levels, and specific recommendations. For instance, NER Identifies key components in the feedback, such as error types (e.g., “SyntaxError”), suggestions (e.g., “use with open( )”), and code references. The loop module 114 additionally or alternatively analyzes the grammatical structure of the feedback to understand relationships between issues and recommended actions. The loop module alternatively or additionally performs sentiment analysis to determine the urgency or criticality of the feedback based on severity indicators, which may be explicitly stated or implied (e.g., “critical”, “minor”).

In some embodiments, the loop module 114 employs predefined rules or heuristics that map common feedback patterns to specific actions. For instance, if the feedback mentions “missing context manager,” the system knows to instruct the code generation module 106 to add with open( ) for file handling. An example rule may be, if security feedback indicates a critical vulnerability, prioritize fixing it over performance enhancements.

In some embodiments, the loop module 114 uses pattern matching techniques to identify known issues in the feedback and link them to corrective actions. For example, patterns like “missing error handling” trigger instructions to add try-except blocks. Once adjustments are identified, the loop module 114 formulates a refined prompt and/or instructs the language model agent(s) 104 to generate the prompt. This prompt is crafted to be clear and directive, specifying exactly what needs to be changed in the code. The loop module 114 may use templates for common refinements. For instance, a template for error handling might look like, “Revise the code to include specific error handling for file operations, such as catching ‘FileNotFoundError’ and ‘JSONDecodeError’. Ensure that all file reads use the ‘with open( )’ context manager.”

The peer review module 116 is generally responsible for providing a final review of the re-generated/refined code using a different language model (relative to the code generation module 106—such as an LLM, VLM, MMLM, etc.) to ensure that the code adheres to the defined quality standards. In some embodiments, once the iterative refinement loop is complete by the loop module 114 (e.g., the computer programming code meets the code quality threshold(s)), the language model agent(s) 104 sends the finalized code to the peer review module 116 for a final quality check.

The peer review module 116 receives and/or generates the prompt and the finalized code to the second language model, instructing it to review the code based on the provided criteria. The second model conducts a detailed analysis, checking for logical correctness, adherence to standards, code efficiency, and/or any missed issues. Once the second model completes the review, the peer review module 116 processes the feedback and determines if any further refinements are necessary. If critical issues are identified, the module 116 may initiate another round of refinement or suggest specific adjustments.

In some embodiments, the peer review module 116 synthesizes feedback from all code evaluation tool(s) 108, providing a comprehensive review that considers all aspects of the code, including overall logic, coherence, and adherence to user-defined standards. For example, the code evaluation tool(s) 108 may determine that Pylint identifies “Line 23 exceeds 80 characters,” bandit flags, “Use of eval( ) function presents a security risk,” and performance Profiler notes, such as “Function calculate( ) has O(n^2) time complexity, suggesting optimization is needed.” The final feedback from the peer review module 116 may be, ““The code overall meets performance, security, and style standards; however, the overall logic in the main processing function can be simplified for better readability. Consider refactoring the loop structure for efficiency and adding inline comments to explain critical processing steps. Additionally, ensure that error messages provide actionable guidance to the end-user, not just generic warnings,” which causes yet another re-generation of code by the code generation module 106.

The peer review module 116 begins by collecting feedback from previous evaluation cycles, which might include error logs, performance metrics, and/or code quality assessments generated by the code evaluation tool(s) 108. Using NLP techniques such as Named Entity Recognition (NER) and dependency parsing, the module 116 identifies key elements within the feedback, such as specific issues, severity levels, and recommended actions taken over the course of the loop/re-generation of code. For instance, NER helps extract relevant entities such as code errors (FileNotFoundError), style issues (PEP 8), and performance concerns. In some embodiments, the module 116 applies filtering rules to prioritize critical feedback items, ensuring that the most important issues are highlighted in the prompt. In some embodiments, NLP sentiment analysis or a custom heuristic model can classify feedback by urgency, categorizing suggestions as “critical,” “important,” or “minor.”

In some embodiments, the peer review module 116 uses a set of predefined templates to construct the prompt based on common review requirements. For instance, using NLP text generation techniques (like GPT-based prompt refinement), the module 116 assembles a coherent and instructive prompt. In some embodiments, NLP techniques like text summarization are employed to condense feedback without losing important details, ensuring that the prompt remains concise yet informative. The prompt is analyzed for clarity, removing ambiguity to ensure that instructions are direct and actionable.

In some embodiments, when the peer review module 116 conducts its final evaluation and identifies that the code does not fully meet the quality standards, the language model agent(s) 104 and/or the peer review module 116 constructs yet another feedback prompt and feeds it to the second language model to provide specific, actionable insights on what needs to be improved. This feedback is then fed back to the language model agent 104 to guide the next round of code refinement. The goal is to iteratively refine the code based on the peer review feedback until it satisfies all criteria for approval. In other words, if the code fails the peer review, the module identifies specific shortcomings, such as missing documentation, suboptimal logic, or failure to adhere to user-defined standards. For instances, the module 116 uses NLP to extract key issues from the peer review feedback and prioritize them based on severity and importance. It formulates a concise, clear prompt that directly addresses the identified issues, providing detailed guidance for the language model agent 104 on how to refine the code. The constructed feedback prompt is sent back to the language model agent(s) 104, instructing it or the second language model to regenerate the code with the necessary adjustments based on the peer review feedback. The language model uses this prompt as a directive for refining the code, ensuring that the identified issues are addressed in the next iteration.

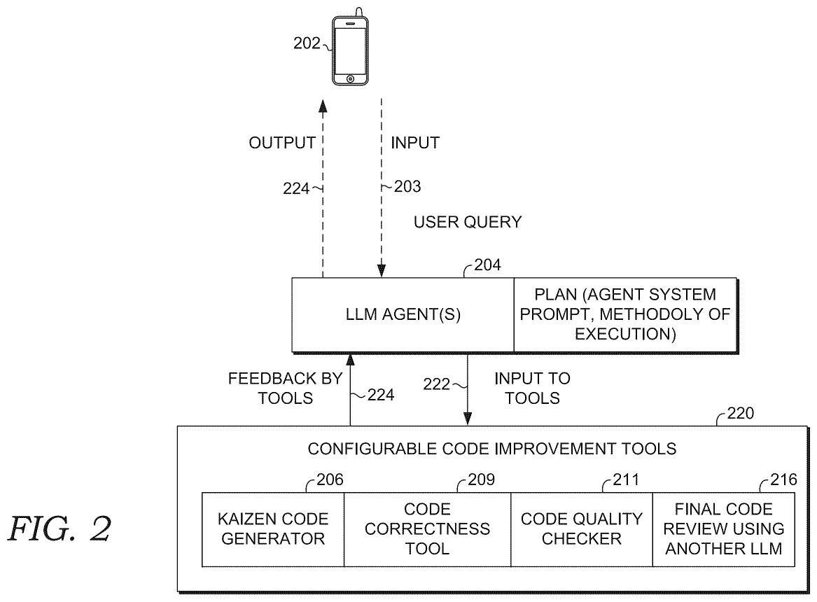

FIG. 2 is a block diagram of an example pipeline 200 for generating and revising computer program code, according to some embodiments. The pipeline 200 includes a user device 202, an LLM agent 204, and configurable code improvement tools 220. In some embodiments, the LLM agent(s) 204 represents or includes the functionality described with respect to the language model agent(s) 104 of FIG. 1. In some embodiments, the configurable code improvement tools 220 represents or includes the code evaluation tool(s) 108 of FIG. 1. The configurable code improvement tools 220 includes a Kaizen code generator 206 (e.g., an LLM, VLM, MMLM, etc.), a code correctness tool 209, a code quality checker 211, and a final code review using another LLM 216. In some embodiments, the Kaizen code generator represents the code generation module 106 of FIG. 1. In some embodiments, the final code review using another language model represents or includes the functionality performed by the peer review module 116 of FIG. 1.

Continuing with the pipeline 200, when user inputs a query 203, the corresponding user device 202 sends the query 203 to the LLM agent 204. The LLM agent 204 responsively generates code either by itself and/or by using one of the code improvement tools 220, such as the Kaizen code generator 206. The LLM agent 204 then uses the appropriate tools from the set of available tools 220 to check for the correctness and quality of the code by sending an instruction 222 to the tools 220. The tools 220 are intrinsically designed to provide feedback 224 to LLM agent 204. Once the LLM agent 204 receives the feedback 224, it refines/re-generates the code resulting in better code. The final output 224 represents the refined code and is transmitted back to the user device 202. The feedback loop eliminates the need for human feedback and is suitable for automation pipelines.

The Kaizen code generator 206 is responsible for continuously generating and refining code based on specific criteria or standards defined by the user, including code quality templates, problem statements, and performance benchmarks. It integrates feedback from each iteration, such as error reports, performance metrics, and stylistic suggestions, to make small, incremental changes aimed at enhancing the code's quality and compliance with standards. By leveraging feedback loops, the generator 206 automates the process of identifying and fixing issues, thus reducing manual intervention and expediting the journey towards high-quality code.

The code correctness tool 209 validates that the generated code functions as intended without errors. This includes checking for syntax correctness, ensuring all dependencies are correctly installed, and/or confirming that the code passes predefined tests. For example, in some embodiments, the code correctness tool 209 runs during the build phase using npm commands like npm run build, which might invoke scripts defined in the package. json file of a Node.js project. These scripts often include commands to, compile code (convert source code (e.g., TypeScript to JavaScript)), run tests (execute unit, integration, or end-to-end tests using testing frameworks like Jest, Mocha, or Jasmine), lint code (use linters like ESLint to check for code quality and adherence to style guides), and check type safety (for projects using TypeScript, type checking ensures that types are correctly used and enforced). The code correctness tool 209 evaluates whether all tests pass, the code compiles without errors, and it meets the specifications outlined in the project requirements.

The code quality checker 211 is generally responsible for the evaluating the overall quality of the generated code based on user-defined standards, guidelines, and/or best practices. This component goes beyond just ensuring the code is correct (e.g., as performed by the code correctness tool), it assesses multiple facets of code quality, including style, readability, maintainability, performance, and/or security.

The code quality checker 211 is responsible for evaluating the generated or refined code against predefined quality standards (e.g., user or system provided), such as those outlined in code quality templates provided by the user. These standards might include coding style (e.g., PEP 8 for Python, Google Java Style Guide), error handling practices, modularity, and optimization requirements. For instance, for style compliance, the code quality checker 211 insures the code follows specified coding style guidelines, such as indentation, naming conventions, and formatting rules. In some embodiments, the code quality checker 211 additionally or alternatively checks if the code is well-structured, easy to read, and maintainable, focusing on aspects like function size, code duplication, and proper commenting. Additionally or alternatively, the code quality checker 211 evaluates if the code is efficient and performs well under expected workloads, identifying potential performance bottlenecks. Additionally or alternatively, the code quality checker 211 analyzes the code for common security vulnerabilities, such as improper input handling or risky function usage. Additionally or alternatively, the code quality checker 211 ensures the code includes necessary documentation, like docstrings or comments, to make it understandable to other developers.

In some embodiments, the code quality checker 211 integrates various tools (e.g., linters like ESLint for JavaScript, static analysis tools like SonarQube) and applies specific rulesets configured to match the quality standards/templates required by the user. The results of the evaluation are synthesized into feedback that helps guide the iterative refinement process managed by the LLM Agent 204. The final code review using another LLM 216 involves using a secondary, distinct language model to conduct an independent and unbiased evaluation of the generated code after it has gone through iterative refinement (e.g., met a code quality threshold). This secondary LLM assesses the code holistically, checking for correctness, adherence to quality standards, and overall coherence, without the biases that may have been introduced by the initial model during previous refinement cycles. The review focuses on ensuring that the code meets all specified criteria, such as functionality, style, performance, and/or security, and provides final feedback or approval before the code is finalized or deployed. This independent review acts as a “peer review,” validating the quality and readiness of the code from a fresh perspective.

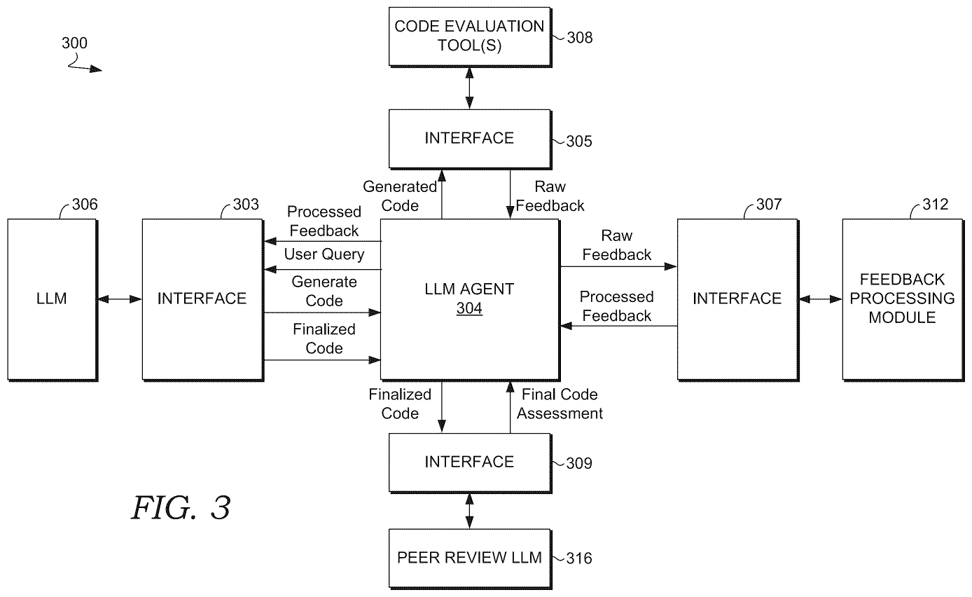

FIG. 3 is a block diagram of a system 300 illustrating how an LLM agent communicates with various components to generate and revise computer programming code, according to some embodiments. The system 300 includes an LLM agent 304 (alternatively referred to as a VLM agent, MMLM agent, machine learning model agent, etc., depending on the type(s) of models used), which is communicatively coupled, via the interfaces 303, 305, 307, and 309, to an LLM 306, a code evaluation tool(s) 308, a feedback processing module 312, and a peer review LLM 316. In some embodiments, the LLM agent 304 represents the language model agent(s) 104 of FIG. 1, the code evaluation tool(s) 308 represents the code evaluation tool(s) 108 of FIG. 1, and/or the peer review LLM 316 represents the peer review module 116 of FIG. 1.

At a first time, the LLM agent 304 receives a “user query” and passes such query to the LLM 306 via the interface 303. In some embodiments, the interface 303 and/or any of the other interfaces 305, 307, and 309 represent any suitable interface, such as an Application Programming Interface (API) (e.g., RESTful APIs, gRPC, or other model-specific APIs). In some embodiments, such “user query” includes problem statement, configuration parameters, and/or any data described with respect to what is received by the user input configuration module 102 of FIG. 1. In some embodiments, the interface request from the interface 303 to the LLM includes parameters specifying the code style, language, and any additional requirements set by the configuration templates. The LLM 306 processes this request and generates code, which is returned to the LLM Agent 304 via a response through the same interface 303. For example, the input or “user query” includes JSON or other structured formats containing the prompt, code specifications, and context. And the output includes “generated code” returned as a text block or code snippet in a structured format.

After such first time, the LLM agent 304 then sends such “generated code” to the interface 305, which gets packaged in a request to the code evaluation tool(s) 308. This component then sends, via the interface 305, raw feedback to the LLM agent 304. For example, The LLM agent 304 interacts with various code evaluation tools using APIs or interfaces specific to each tool. For instance, a compiler tool might have a REST API or a CLI interface that the LLM agent 304 can call programmatically. The LLM Agent 304 sends the “generated code” to these tools via API calls, requesting specific checks (e.g., compile code, check for memory leaks). The tool(s) 308 perform the requested action and return feedback, such as errors, warnings, or performance data, through the API response. In other words, the input is code snippets and configuration commands in a structured format (e.g., JSON, XML). The output is raw feedback data, including error messages, success/failure status, and detailed diagnostic information.

The LLM agent 304 then responsively provides the “raw feedback” to the interface 307, which forwards an interface request to the feedback processing module 312 to request processing of the raw feedback. For example, the interface 307 may represent internal APIs or direct function calls within the system 300. That is, the LLM Agent 304 sends the “raw feedback” data collected from the code evaluation tool(s) 308 to the feedback processing module 312 using internal APIs. The feedback processing module a 312 analyzes this feedback, aggregates the results, and prepares structured information that the LLM agent 304 can use to refine the code. In other words, the input is raw feedback data from tool(s) 308. The output is processed feedback ready for code refinement.

Next, the LLM agent 304 passes the “processed feedback” back to the LLM 306 for code refinement to get “finalized code.” The interface 303 may represent the continuous use of REST APIs, gRPC, or WebSocket connections for real-time updates. After receiving the “processed feedback,” the LLM agent 304 sends the original code and processed feedback data back to the LLM 306 through APIs for refinement. The LLM 306 uses this information to modify/re-generate the code, improving aspects identified in the feedback, such as error handling or memory management. This process repeats iteratively, with the LLM agent 304 coordinating multiple calls to the LLM 306 until the code meets the desired quality standards. The input is code plus feedback from evaluation tool(s) 308. The output is updated code reflecting refinements based on feedback.

Next, the LLM agent 304 passes the “finalized code” to the peer review LLM 316, via the interface 309 and the peer review LLM 316 responsively provides a “final code assessment.” The interface 309 used may be interfaces, such as model-specific APIs distinct from those used in initial code generation (to avoid model bias). The LLM agent 304 uses the interface 309 to send the finalized code to a separate peer review LLM 316 for independent evaluation. The peer review LLM 316 analyzes the code and provides a final quality assessment, which is returned to the LLM agent 304. The input is the final code submission or “finalized code.” The output is peer review feedback, including a quality/final code assessment and/or suggestions for final adjustments.

In an illustrative example of the “final code assessment,” it may include code correctness, such as “the core functionality of the code is correct. The script processes the input data as expected and calculates the required metrics. All test cases pass, and no runtime errors were encountered during execution.” In another example, there may be an assessment for code style and formatting, such as, “The code generally follows the specified PEP 8 style guidelines for Python.

Suggestion: While most variable names are descriptive, consider renaming the variable x to something more meaningful, such as average_value, to improve readability.” In yet another example, error handling might be a part of the assessment—“The code includes error handling for common issues such as file not found (FileNotFoundError) and JSON decoding errors (JSONDecodeError). Suggestion: The error messages are functional but could be more user-friendly. Instead of printing ‘Error: Failed to decode JSON,’ consider printing, ‘Error: The input file contains invalid JSON format. Please check the file content.’” In yet another example, “The performance is generally good for small to medium datasets. However, with larger datasets, the current approach to processing data line by line might cause slowdowns. Suggestion: Consider optimizing the loop to batch-process the data in chunks, reducing memory overhead and improving performance for large files.” In some embodiments, there is an overall assessment, such as “the code meets the core functional requirements and follows most of the specified quality guidelines. With minor adjustments to variable names, error messages, performance, and comments, the code will be in excellent shape for final deployment.”

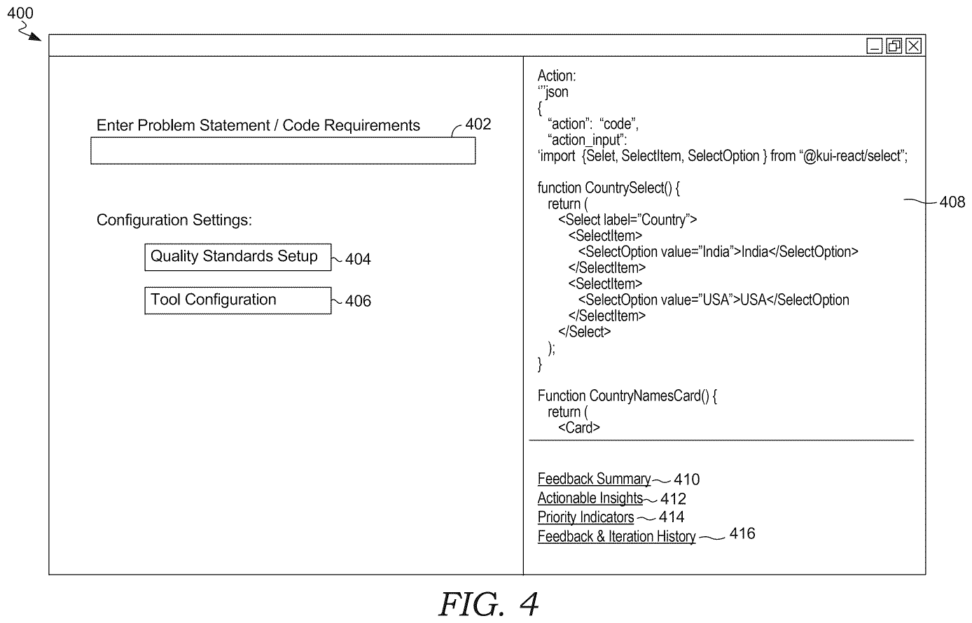

FIG. 4 is a screenshot of an example user interface page 400 illustrating how computer programming code is generated and revised, according to some embodiments. The user interface element 402 represents a text field that is configured to receive a problem statement and/or other code requirements. The UI elements 404 and 406 represent different configuration settings that users can set. For example, the “quality standards setup” element 404 represents an element (e.g., button) selectable by a user so that the user can specify code quality templates as described herein. For example, the element 404 may represent a drop-down menus, sliders, or toggle switches to set quality criteria such as performance, security, style, and error handling. The “tool configuration” element 406 represents an element selectable by a user so they can specify the code evaluation tools to be used in or as a part of the code evaluation tool(s) 108 of FIG. 1. For example, the element 406 may represent options to select which tools (e.g., compilers, analyzers) to use during the evaluation phase and how they should be configured.

The user interface page 400 further includes a section 408 that includes the actual source code. In some embodiments, such source code represents what is generated by the code generation module 106 before or after having been evaluated by the code evaluation tool(s) 108, the iterative improvement loop module 114, and/or the peer review module 116. The user interface page 400 further includes a section that includes the user interface elements 410, 412, 414, and 416 (e.g., buttons or links). User interface element 410 “feedback summaries” is responsible for displaying feedback from the code evaluation tool(s) 108 in an organized manner so that the user can see how the code needs to be modified. The “Actionable Insights” element 412 highlights key feedback, providing suggestions on what needs to be fixed or optimized in the code. Element 412 breaks down the feedback into clear, prioritized steps that can be immediately addressed. This informs the user what exactly needs to be done to fix the issues or optimize the code. For example, an actionable insight might be, “Rename variable x to average_value for improved readability.”

The priority indicators 414 are visual cues (e.g., color coding, icons) to indicate critical issues versus minor suggestions. For instance, visual cues like color coding and icons can be used in the actionable insights section to help developers or the LLM agent quickly understand the priority of feedback. This can be particularly useful for distinguishing between critical issues that need immediate attention and minor suggestions that can be addressed later (e.g., a red color indicates high priority, whereas a green color indicates low priority).

The feedback and iteration history element 416 allows users to track the history of changes, feedback, and decisions made during the iterative code refinement process. For example, the element 416 may be selectable to produce a visual timeline that shows each cycle of refinement, highlighting key actions, feedback points, and major code changes. Some embodiments compare different versions of the code side-by-side, showing what was changed in response to feedback.

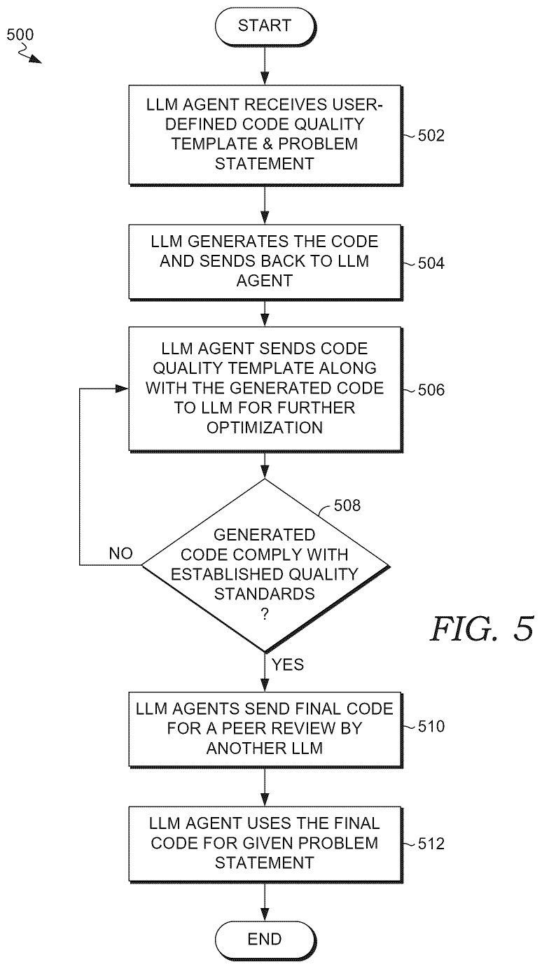

Now referring to FIGS. 5, 6, 7, and 8, each block of processes 500, 600, 700, and 800 described herein, comprises a computing process that may be performed using any combination of hardware, firmware, and/or software. For instance, various functions may be carried out by a processor executing instructions stored in memory, dedicated AI hardware accelerator circuitry, or the like. The processes may also be embodied as computer-usable instructions stored on computer storage media. The methods may be provided by a standalone application, a service or hosted service (standalone or in combination with another hosted service), or a plug-in to another product, to name a few. In addition, the processes 500, 600, 700, and 800 are described, by way of example, with respect to the system 100 of FIG. 1. However, these processes may additionally or alternatively be executed by any one system, or any combination of systems, including, but not limited to, those described herein.

FIG. 5 is a flow diagram of an example process 500 for generating and revising computer program code, according to some embodiments. Per block 502, an LLM agent receives a user-defined code quality template and a problem statement. For example, the user configures a template (e.g., the user-defined code quality template) to ensure the code adheres to PEP 8 for Python, has specific error handling, and is optimized for large datasets. In an example off the problem statement, the user may input the following characters, “Create a Python script that reads a CSV file and calculates the average value for each column.”.

Per block 504, an LLM generates code and sends back to the LLM agent. In other words, the LLM generates the initial version of the code based on the problem statement and/or code quality template and sends the generated code back to the LLM agent for further evaluation. For example, the LLM generates a Python script that opens a CSV file, reads its contents, and calculates column-wise averages. Per block 506, the LLM agent sends the code quality template along with the generated code to the LLM for further optimization. For example, The LLM agent sends the generated Python script and asks the LLM to ensure it follows PEP 8, handles errors properly, and is optimized for performance. The LLM ensures the code follows PEP 8, handles errors properly, and is optimized for performance by leveraging code evaluation tools and applying specific rulesets during the optimization step. First, the LLM is prompted with instructions to refine the code to comply with PEP 8, such as ensuring correct indentation, variable naming, and formatting. For error handling, the LLM is directed to include proper exception management, such as using try-except blocks for potential issues like file I/O errors. Performance optimization involves analyzing code structures, such as loops or data handling mechanisms, and suggesting more efficient algorithms or techniques, such as batching or memory-efficient operations. These refinements are guided by the user's pre-configured code quality templates and evaluated by external tools (e.g., linters, static analyzers) for compliance.

Per block 308, some embodiments determine whether the generated code complies with established quality standards (e.g., as defined by the quality template and/or other rules). If the generated code does not comply with such standards, a loop is performed such that particular embodiments iterate blocks 506 and 508 until the generated code meets the established quality standards. For example, upon evaluation, the LLM agent finds that the code lacks proper error handling, so the process continues iteratively until this issue is resolved. For example, upon evaluation, the system uses automated tools such as static analyzers (e.g., Bandit or ESLint) to assess the code's compliance with the error handling requirements specified in the code quality template. If the tools detect missing or insufficient error handling (e.g., no try-except blocks for potential file handling issues), the system identifies this as a gap. The LLM agent and LLM then refines the code by generating new iterations with more robust error handling, such as adding specific exceptions like FileNotFoundError. This process continues iteratively, with the code being re-evaluated and refined in each cycle, until the code fully adheres to the error handling guidelines within the code quality template defined by the user.

Per block 510, if the generated code complies with the established quality standards, then the LLM agent sends final code for a peer review by another LLM. For example, a second LLM reviews the code and suggests adding comments for better readability and more specific error messages. In some embodiments, such second or other LLM has different architecture, training, fine-tuning, RAG system, and/or other differences compared to the LLM at block 504 (e.g., BERT versus GPT). Alternatively, in some embodiments, such second LLM has the same architecture as the first LLM (e.g., two GPT models trained on different data sets).

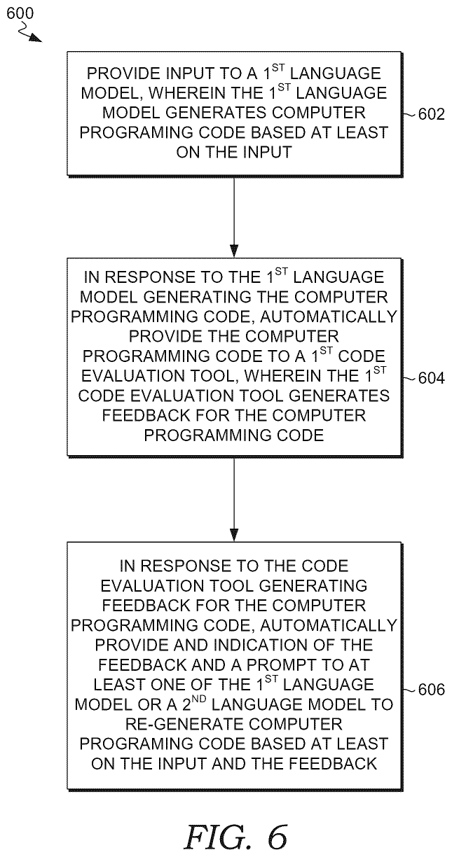

FIG. 6 is a flow diagram of an example process 600 for re-generating or revising computer programming code, according to some embodiments. Per block 602, some embodiments (e.g., a language model agent) first provide input to a first language model (e.g., a GPT LLM), wherein the first language model generates computer programming code based at least on the input. “Computer programming code” as described herein refers to a set of written instructions that a computer can interpret and/or execute. Computer programming code encompasses any type of code, whether it is source code, intermediate bytecode, or low-level machine code that the processor executes. For example, computer programming code includes source code, machine code, bytecode, executable code, and/or script code.

In some embodiments, such “input” as indicated in block 602 includes at least one of: a problem statement indicative of a problem or task specified in natural language that a user wants to solved or addressed. For example, a problem statement might read, “Create a Python script that reads a CSV file containing student grades, calculates the average grade for each student, and writes the results to a new CSV file. The script should handle file input/output errors and ensure that invalid data entries are skipped with a warning.” Additionally or alternatively, the input can include a code quality template indicating how generated code should be structured, written, or behave. For example, the following is a code quality template for code structure and style: code Structure: Code must be modular, with each function performing a single, well-defined task. Functions should have clear and descriptive names. No function should exceed 30 lines of code, except when absolutely necessary. Avoid deep nesting of conditionals or loops (maximum depth of 3). Coding Style: The code must follow PEP 8 guidelines (for Python): Use 4 spaces for indentation. Limit all lines to a maximum of 79 characters. Use meaningful variable names (no single-letter names except for loop counters). Include proper docstrings and comments to explain the purpose of each function and important code blocks. Avoid using global variables. Alternatively or additionally the input can be a list of code evaluation tools to be used for the feedback including the first code evaluation tool.

Continuing with block 602, in some embodiments, the language model is an LLM that uses natural language processing (NLP) techniques and a transformer-based architecture with an attention mechanism to interpret the input and generate code. The self-attention mechanism allows the model to weigh the importance of different parts of the input (e.g., problem statement, code quality template, and feedback from code evaluation tools) by analyzing the contextual relationships between words and phrases. The model first tokenizes the input text and encodes it into embeddings, which are processed layer-by-layer through the transformer's attention heads. These heads focus on relevant segments of the input, such as instructions related to functionality (from the problem statement) or specific quality requirements (from the code quality template). The model then predicts the next token or code snippet by generating syntactically and semantically valid code, considering the structure and behavior required by the input and generating a coherent output that adheres to the provided constraints. This iterative generation continues until the code fully aligns with the input prompts.

Per block 604, in response to the first language model generating the computer programming code, some embodiments (e.g., the language model agent) automatically provides the computer programming code to a first code evaluation tool, wherein the first code evaluation tool generates feedback for the computer programming code. A “code evaluation tool” is a software tool or utility designed to analyze, assess, and provide feedback on the quality, correctness, performance, security, or compliance of computer programming code. These tools automatically review code based on predefined criteria or rules and identify potential issues such as syntax errors, security vulnerabilities, performance bottlenecks, coding style violations, or unhandled exceptions.

For example, the first code evaluation tool can be a compiler, an interpreter, a code compliance tool, a static code analyzer, a security analysis tool, a performance profiler, a memory leak detector, a dependency and vulnerability scanner, a test coverage analyzer, a code complexity analyzer, a Continuous Integration (CI) tool, a linting tool, and/or a language model (e.g., an LLM, VLM, MMLM, etc.). A compiler is a program that translates source code written in a high-level programming language into machine code or bytecode that a computer's processor can execute. Unlike an interpreter, a compiler processes the entire code at once, generating an executable file before the program is run. An interpreter is a program that directly executes code line by line, converting high-level instructions into machine-level actions without needing to compile the code first. Examples include the Python interpreter or JavaScript's Node.js runtime.

A code compliance tool checks whether the code adheres to specific industry or organizational coding standards and best practices, ensuring consistent style and quality. Examples include Checkstyle for Java or PEP8 compliance for Python. A static code analyzer examines code without executing it to detect potential issues such as bugs, vulnerabilities, or deviations from coding standards. Examples include SonarQube and Coverity. A security analysis tool scans code for vulnerabilities like SQL injection, insecure input handling, or weak encryption, helping to identify security risks before deployment. Examples include Bandit for Python and OWASP ZAP. A performance profiler monitors the execution of a program to measure its performance, identifying bottlenecks or inefficient code that impacts speed or resource usage. Examples include Valgrind and Intel VTune.

A memory leak detector identifies areas in code where allocated memory is not properly released, leading to inefficient memory usage and potential crashes. Examples include Valgrind's Memcheck and AddressSanitizer. A dependency and vulnerability scanner scans for outdated, insecure, or vulnerable libraries and dependencies in a project, recommending updates or patches to prevent exploitation. Examples include Snyk and Dependabot. A test coverage analyzer measures how much of the codebase is covered by tests, ensuring critical paths are tested and identifying untested code. Examples include JaCoCo for Java and Coverage. py for Python. A code complexity analyzer evaluates the complexity of code by analyzing factors like the number of control flow paths (e.g., cyclomatic complexity), helping maintain code readability and maintainability. Examples include Cyclomatic Complexity in SonarQube.

A Continuous Integration (CI) tool automates the process of building, testing, and integrating code changes continuously, ensuring that new code works well with the existing codebase. Examples include Jenkins, Travis CI, and CircleCI. A linting tool checks code for stylistic errors and enforces coding conventions, helping to maintain consistency and readability across the codebase. Examples include ESLint for JavaScript and Pylint for Python.

As described herein, the “feedback” at block 604 can be any suitable feedback dependent on the code evaluation tool used. For example, the feedback can include any suitable code analysis artifact, such as a linting report (A detailed report from a linting tool (e.g., ESLint, Pylint) listing coding style violations, formatting errors, and suggestions for improvements in code structure), a static analysis report, a test coverage report a performance profiling report, a security vulnerability report, a memory leak detection report, a dependency vulnerability report, a code complexity report, a build success/failure log, and/or a compiler error/warning report.

Per block 606, in response to the code evaluation tool generating feedback for the computer programming code, some embodiments automatically provide an indication of the feedback and a prompt to at least one of the first language model or a second language model to re-generate computer programming code based at least on the input and the feedback. For example, re-generating computer programming code can be revising or modifying the existing computer programming code. In an illustrative example, the original computer programming code me be the following, which is Python code (without error handling and optimization):
def read_and_process_csv(file_path):
   data=open(file_path).readlines( )
   averages=[sum(map(float, row.split(',')))/len(row.split(',')) for row in data]
   print(averages)

The following represents revised/modified Python code (with error handling and optimization):
import csv
def read_and_process_csv(file_path):
   try:
      with open(file_path, ‘r’) as file:
         reader=csv. reader(file)
         data=[list(map(float, row)) for row in reader]
         averages=[sum(col)/len(col) for col in zip(*data)]
         print(averages)
   except FileNotFoundError:
      print(f“Error: the file ‘{file_path}’ was not found.”)
   except ValueError:
      print(“Error: Could not convert data to float. Please check the file for invalid entries.”)
   except Exception as e:
      print(f“An unexpected error occurred: {e}”)

In some embodiments, “re-generated” code means code that is completely different (not merely revised or modified) relative to the original computer programming code. Accordingly, with respect to block 606, when the code evaluation tool generates feedback, such as identifying missing error handling or performance bottlenecks, the system processes this feedback through an automated pipeline. This feedback is parsed using techniques like natural language processing (NLP) to extract key issues (e.g., security vulnerabilities or coding style violations). The system then formulates a prompt that includes the original user inputs (e.g., problem statement, code quality templates) along with the newly identified feedback. This prompt is passed to the first language model, instructing it to re-generate or revise the code by addressing the specific issues while still adhering to the original requirements provided by the user.

In some embodiments, the re-generated code is then evaluated again in an iterative improvement loop (e.g., via the iterative improvement loop module 114 of FIG. 1). In some embodiments, such iterative loop includes the following: various embodiments determine that the re-generated code does not meet a code quality threshold. In response to the determining that the re-generated code does not meet the code quality threshold, some embodiments cause the first language model to re-generate code until the code quality threshold is met. In some embodiments, this is described by block 508 of FIG. 5. In some embodiments, this step includes using code evaluation tools (such as static analyzers, linters, or test coverage analyzers) to assess the re-generated/revised/modified code against the user-defined code quality templates. These tools provide feedback based on predefined rules for style, performance, security, and/or functionality. If the feedback indicates that the code does not meet the specified quality threshold (e.g., missing error handling, style violations, or inefficient algorithms), in some embodiments this information is processed using an NLP-based system to extract actionable insights. The system then dynamically generates a new prompt for the first language model, which includes the original input (problem statement, code quality template) along with the feedback. This process continues iteratively, with the model re-generating code and the evaluation tools reassessing it, until the code meets all required quality standards, ensuring that the final output satisfies the quality threshold.

Based at least on the code quality threshold being met, some embodiments automatically provide, to the second language model, finalized computer programming code and a request to perform a final evaluation of the finalized computer programming code. Examples of this are described with respect to block 510 of FIG. 5. In some embodiments, this second model serves as a peer reviewer, ensuring that the final evaluation is unbiased and thorough. The system generates a structured prompt that includes the finalized code, the problem statement, and/or a request for the second language model to verify adherence to the problem's requirements, coding standards, and performance criteria. The second model reviews the code holistically, identifying any potential overlooked issues, providing final feedback, or confirming the code is ready for deployment, ensuring that the final code quality is robust and unbiased before use.

In some embodiments, multiple code evaluation tools are used for generating and/or re-generating the computer programming code. That is, in response to the first language model generating the computer programming code, some embodiments automatically provide the computer programming code to a second code evaluation tool, and wherein the second code evaluation tool generates second feedback for the computer programming code. Accordingly, multiple code evaluation tools may be used in parallel or sequentially to analyze different (and/or the same) aspects of the generated code, providing comprehensive feedback. For example, a linter checks for style and formatting issues, a static code analyzer detects bugs and vulnerabilities, a performance profiler identifies inefficiencies, and a test coverage tool ensures sufficient testing. Each tool generates its own report or feedback based on its specific evaluation criteria (and/or the user input), and the system aggregates these outputs. The combined feedback is then processed to highlight critical issues across performance, security, style, and functionality, which are used to refine the code in the iterative development loop. The re-generated code is based on the first feedback and the second feedback.

In some embodiments, each block of the process 600 is performed using a Large Language Model (LLM) Reasoning and Action (ReAct) agent (although other types of language models may be used, such as VLMs, MMLMs, small language models (SLMs), etc.) that communicates with the first language model and the first code evaluation tool. In alternative embodiments, the first language model or related actor is the entity that performs the process 600. In this way, the language model agent or language mode itself can, for example, cause the first language model to generate computer programming code based at least on user input; in response to the causing the first language model to generate the computer programming code, automatically cause a first code evaluation tool to generate feedback for the computer programming code. And in response to the causing of the first code evaluation tool to generate feedback for the computer programming code, automatically cause at least one of the first language model or a second language model to revise the computer programming code based at least on the user input and the feedback.

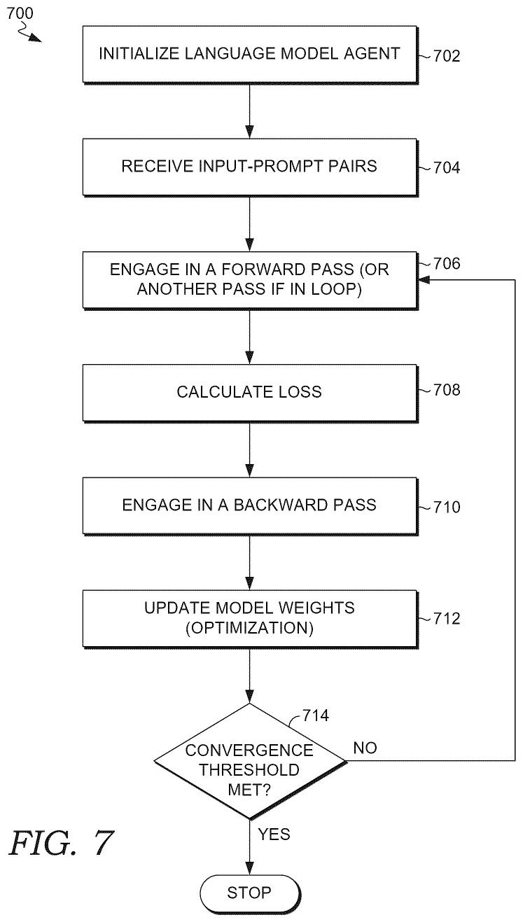

FIG. 7 is a flow diagram of an example process 700 for tuning (e.g., train by prompt-tuning or fine-tuning) a language model agent to generate a prompt, according to some embodiments. Prompt-tuning and fine-tuning are techniques used to adapt a language model agent to generate specific outputs (prompts) based on particular inputs. This training approach involves using supervised learning techniques with input-output pairs, where the input represents user input (e.g., code quality templates or problem statements) and/or feedback (e.g., from multiple code evaluation tools), and the output represents the optimized prompt. The model learns from these examples using gradient-based optimization, and the training loop iterates until convergence is achieved.

Per block 702, some embodiments, initialize a language model agent (e.g., initializing an LLM agent's architecture). This can be based on a pre-trained model (such as GPT-3, GPT-4) that will be fine-tuned for the task of generating optimized prompts. One goal may be to ensure the agent has a solid baseline understanding of natural language processing. In an example illustration of block 702, some embodiments initialize the LLM agent with pre-trained weights, then prepare the training pipeline with proper datasets, including input-output pairs for prompt generation.

Per block 704, some embodiments receive input-prompt (output) pairs, which represents the training data. In other words, a dataset of input-output pairs are generated where the input represents user input (e.g., code quality templates, problem statements, and specific requirements), feedback generated by tools like linters (e.g., ESLint), static analysis tools (e.g., SonarQube), or peer review feedback (e.g., missing comments, improper error handling). The output of the input-prompt pairs represents the expected output, which is a properly structured and actionable prompt that would be passed back to the language model for generating and/or refining the code based on the input and/or the feedback. These examples are used to teach the language model agent how to structure prompts that guide the main LLM in code generation and refinement.

For example, an example input-prompt pairs includes the following: Input: User Problem Statement: “Create a Python script to read a CSV file and calculate column averages.” Code Quality Template: “Ensure PEP 8 compliance, handle file-related errors, optimize for large files” and feedback: “Code lacks specific error handling for FileNotFoundError, and variable names are not descriptive.” The expected output (e.g., prompt) is as follows: “Revise the code to include specific handling for FileNotFoundError, and rename the variable x to average_value to improve readability and PEP 8 compliance.”

Per block 706, some embodiments engage in a forward pass (or another pass if in loop (e.g., a “no” decision at block 714)). For each input-prompt pair, some embodiments feed the input (user input, feedback) into the language model agent. The agent processes the input and generates an initial output, which is a candidate prompt. The goal is to generate a first version of the prompt that reflects the input's problem statement and feedback. The model generates text output (e.g., a prompt) based on its understanding of the input. For example, the model takes in the problem statement and feedback (“Code lacks specific error handling”) and generates a prompt like: “Add FileNotFoundError handling to the code and rename the variable x for better readability.”

Per block 708, some embodiments calculate a loss. In other words, particular embodiments compare the language model agent's generated prompt to the expected prompt (e.g., the ground truth from the training data) using a loss function, such as Cross-Entropy Loss for language tasks. The goal is to measure how well the generated prompt matches the target prompt. The Cross-Entropy Loss calculates the difference between the probabilities assigned to the words in the generated prompt versus the expected prompt. A higher loss indicates a greater mismatch, while a lower loss means the generated prompt is close to the target. For example, the target prompt is “Add FileNotFoundError handling and rename variable x to average_value.” And the generated prompt is “Add error handling and rename x.” The loss function computes how different the generated output is from the expected output.

Per block 710, some embodiments engage in a backward pass (e.g., via Gradient Descent). In other words, various embodiments perform a backward pass through the language model agent to calculate the gradients of the loss with respect to the model's parameters. This involves computing the gradients for each layer of the model based on the error (loss) calculated at bock 708. The goal is to determine how the model's weights should be updated to reduce the error in future iterations. Gradients help the model understand how much to adjust its parameters (weights) in order to generate better outputs in the next iteration.

Per block 712, some embodiments update model weights for optimization. To do this, some embodiments use an optimization algorithm, such as Stochastic Gradient Descent (SGD) or Adam, to update the model's weights based on the gradients calculated at block 710. The goal is to iteratively improve the model's ability to generate accurate prompts by reducing the loss over time. The optimizer adjusts the model parameters slightly with each iteration, aiming to minimize the overall loss and make the model's predictions closer to the target outputs. For example, after adjusting the weights, the next iteration should generate a more precise prompt like: “Handle FileNotFoundError and rename variable x to average_value.”

Per block 714, some embodiments determine whether a convergence threshold has been met. Various embodiments stop the training process 700 when a convergence threshold is reached, either based on a predefined convergence threshold (e.g., when the loss falls below a certain value) and/or after a set number of iterations (epochs). The goal is to end training when the language model agent consistently generates accurate prompts that align with the expected outputs. The stopping criteria can also involve checking validation data to ensure the model generalizes well beyond the training set. For example, training stops when the Cross-Entropy Loss is below 0.01, indicating that the model is consistently producing highly accurate prompts.

If the convergence threshold has not been met (e.g., a “no” decision at block 714), then particular embodiments engage in blocks 706 (e.g., another pass), 708, 710, 712, and 714 (and/or new input-prompt pairs are received at block 704). In other words, these steps are repeated for multiple input-output pairs in the training dataset. The agent iteratively processes inputs, computes loss, updates its weights, and refines its outputs over time. The goal is to iteratively improve the model's performance, minimizing the loss with each step and making the language model agent more effective at generating prompts based on user inputs and/or feedback. The training loop continues until the model reaches a satisfactory level of performance.

After training, some embodiments evaluate the language model agent on a separate test set that includes unseen input-output pairs. The goal is to verify that the model can generalize to new data and generate accurate prompts when given new problem statements and feedback. This step ensures that the language model agent performs well in real-world scenarios, not just on the training data.

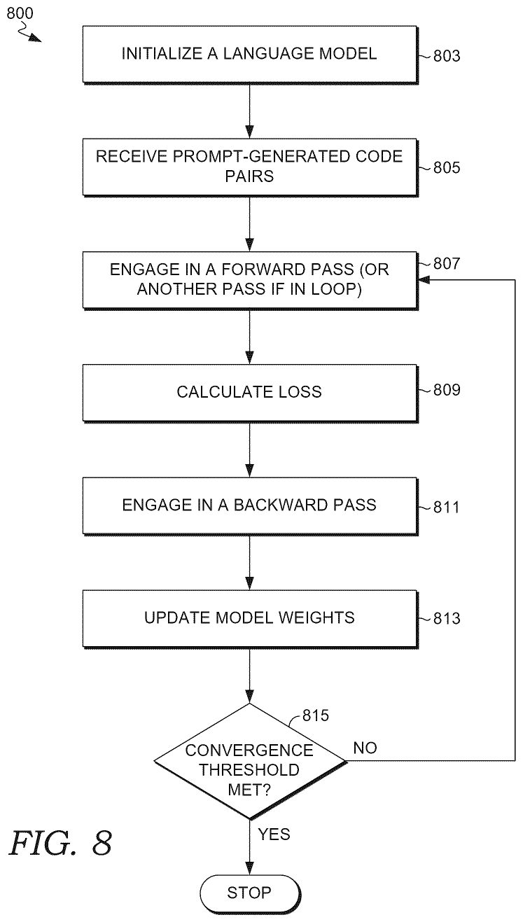

FIG. 8 is a flow diagram of an example process 800 for tuning (e.g., fine-tuning) a language model (e.g., an LLM, VLM, MMLM, etc.) to generate computer programming code, according to some embodiments. In other words, the goal is to train the language model for code generation based on prompts created by the LLM agent. This approach uses input-output pairs where the input includes the prompts generated by the language model agent (based on user input, code evaluation tools, or peer review data) and the output is the generated code. The model learns to generate the appropriate code by using gradient-based optimization techniques.

Per block 803, some embodiments initialize a language model. For instance, some embodiments start by initializing an LLM with pre-trained weights. This serves as a starting point to further fine-tune the model specifically for generating code based on prompts created by the LLM agent. The goal is to ensure the LLM has a basic understanding of programming languages and natural language text. Some embodiments load pre-trained weights from a general-purpose LLM that has been trained on large corpora, including code and text. For example, some embodiments initialize a pre-trained LLM with knowledge of Python, JavaScript, and other programming languages.

Per block 805, some embodiments receive prompt (input)-generated code (output) pairs. Accordingly, a dataset of input-output pairs are created where the input represents prompts created by the LLM agent, which include user input in the form of problem statements and code quality templates, feedback from code evaluation tools, and/or peer review outputs. The output (e.g., the ground truth) is the desired code that satisfies the problem statement, adheres to code quality standards, addresses feedback, and/or is responsive to peer review. The goal is to teach the language model how to generate code based on specific prompts and feedback provided by the agent. An example input-output pair may be: input (Prompt): “Generate a Python script that reads a CSV file, calculates averages for each column, follows PEP 8 standards, and includes specific error handling for FileNotFoundError.” Expected Output (Generated Code) may be: “Copy code try: with open(‘data. csv’, ‘r’) as file: data=[list(map(float, row)) for row in csv. reader(file)] averages=[sum(col)/len(col) for col in zip(*data)] print(averages) except FileNotFoundError: print(“Error: File not found.”).”

Per block 807, some embodiments engage in a forward pass. For each input-output pair, embodiments feed the input prompt (created by the LLM agent) into the language model. The language model processes the prompt and generates a corresponding block of code. The model generates code as text output, based on its understanding of the programming language and the provided prompt. Per block 809, some embodiments calculate a loss. Thus some embodiments compare the language model's generated code with the expected code (the ground truth) in the training set using a loss function, such as Cross-Entropy Loss. The loss function computes the difference between the generated code and the expected output. For example, the loss function identifies missing error handling, and the loss value reflects the discrepancy.

Per block 811, some embodiments engage in a backward pass. Some embodiments perform a backward pass to compute gradients with respect to the model's parameters, based on the calculated loss from block 809. The gradients represent how much each model parameter (weight) contributes to the error, helping the optimizer adjust these weights in the next step. For example, the model identifies that it needs to adjust weights associated with generating try-except blocks, so it can better predict error handling code in future iterations.

Per block 813, some embodiments update the model weights. Some embodiments use an optimization algorithm, such as Stochastic Gradient Descent (SGD) or Adam, to update the model's weights based on the gradients calculated in the backward pass. The goal is to improve the model's ability to generate accurate code by minimizing the loss over time. The optimization algorithm adjusts the weights slightly in each iteration, refining the model's output and improving the quality of generated code. For example, after weight adjustment, the model learns to prioritize adding error handling blocks (try-except) when generating code from prompts that mention error handling.

Per block 815, it is determined whether a convergence threshold has been met. If it has been met (e.g., “yes” decision), the training process stops when a convergence threshold is reached, such as when the loss function falls below a certain value or after a set number of iterations. The goal is to ensure the language model is well-trained and capable of generating accurate code with minimal discrepancies from the target outputs. In some embodiments, the model's convergence is often checked by monitoring validation loss, ensuring that the model does not overfit or underperform. In an illustrative example, training stops when the Cross-Entropy Loss is below 0.05, indicating that the LLM consistently generates high-quality code that closely matches the expected output.

If the convergence threshold has not been met (e.g., a “no” decision at block 815), then blocks 807 through 815 (and/or block 805 to receive new pairs) are repeated. That is, the model iterates through the data, refining its ability to generate code based on various prompts. The goals is to continuously reduce the loss and improve the quality of the code generated in response to prompts. The model undergoes multiple training epochs to optimize its weights and minimize errors in code generation. For example, the LLM is repeatedly exposed to prompts about different programming problems, refining its ability to generate code that meets the desired specifications and quality standards.

In some embodiments, after training, some embodiments evaluate the model on a separate test set that includes unseen input-output pairs. This ensures the LLM can generalize and generate accurate code for new, unseen prompts. The goal is to verify that the LLM can generalize well to new problems and generate high-quality code in different scenarios. This evaluation checks the LLM's ability to generate code in real-world applications beyond the training set.

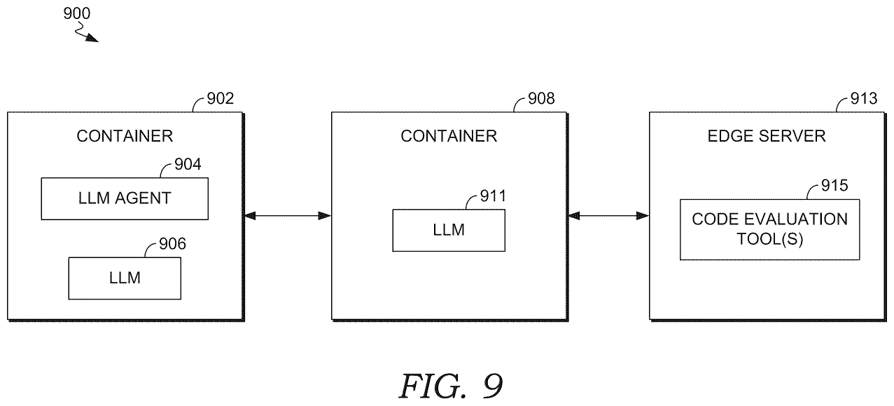

FIG. 9 is a block diagram of an example architecture 900 that illustrates where LLM/VLM/MMLM/etc. agents and LLMs/VLMs/MMLMs/etc. may be hosted, according to some embodiments. The container 902 includes an LLM agent 904 and an LLM 906. The container 908 includes an LLM 911. The edge server 913 includes one or more code evaluation tools 915. Each one of these components are communicatively coupled. In some embodiments, a “container” is an OS-level virtualization package that encapsulates an entire microservice, including the API layer, server layer, runtime layer, and/or model engine. Containers are lightweight and portable, making it easier to deploy across different environments. One or more containers may be included in any suitable physical host or computing device, such one or more machines in a data center, cloud servers, edge servers, or on-premises servers. In some embodiments, the LLM 906 represents a first language model, such as the code generation module 106 of FIG. 1. In some embodiments, the LLM 911 represents a second language model or a “peer review” language model as described, for example, with respect to the peer review module 116 of FIG. 1. In some embodiments, one or more components of the architecture 900 of FIG. 9 is hosted at the computing device as described with respect to FIG. 11 and/or the datacenter as described with respect to FIG. 12.

The edge server 913 is a server that resides closer to the end user or device in a network, typically outside of a centralized data center or cloud infrastructure. Its role is to reduce latency and improve performance by processing data or delivering content closer to where it is generated or consumed. Edge servers are a component of edge computing, which aims to bring computation and data storage closer to the physical location of the user or data source. Since edge servers are closer to the source of data (e.g., sensors, IoT devices, or user devices), they can process data in near real-time, which is useful for time-sensitive applications like autonomous driving, augmented reality (AR), or industrial automation.

It is understood that although the system architecture 900 illustrates a specific architecture setup, any other combination may be realized. For example, in some embodiments, the container 908 alternatively or additionally includes an LLM agent. In some embodiments, the container 902 alternatively includes the LLM 911 and/or the LLM 906. In some embodiments, the code evaluation tool(s) 913 are additionally or alternatively hosted within the container 902 or the container 908.

In some embodiments, each of the LLMs 906, 911, and LLM agent 904 (and/or any other model) is packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the LLMs (e.g., weights and biases). In some instances, such as where the model is small enough (e.g., has a small enough number of parameters), the model may be included within the container itself. In other examples—such as where the model is large—the model may be hosted/stored in the cloud (e.g., in a data center) and/or may be hosted on-premises and/or at the edge (e.g., on a local server or computing device, but outside of the container). In such embodiments, the model may be accessible via one or more APIs—e.g., REST APIs. As such, and in some embodiments, the models and/or agents described herein may be deployed as an inference microservice to accelerate deployment of models on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the model(s) (e.g., that has been optimized for high performance inference), an inference runtime software to execute the model(s) and provide outputs/responses to inputs (e.g., generated code, etc.), and enterprise management software to provide health checks, identity, and/or other monitoring. In some embodiments, the inference microservice may include software to perform in-place replacement and/or updating to the model(s). When replacing or updating, the software that performs the replacement/updating may maintain user configurations of the inference runtime software and enterprise management software.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents-e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.-as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 10A is a block diagram of an example generative language model system 1000 suitable for use in implementing at least some embodiments of the present disclosure. In the example illustrated in FIG. 10A, the generative language model system 1000 includes a retrieval augmented generation (RAG) component 1092, an input processor 1005, a tokenizer 1010, an embedding component 1020, plug-ins/APIs 1095, and a generative language model (LM) 1030 (which may include an LLM, a VLM, a multi-modal LM, etc.).

At a high level, the input processor 1005 may receive an input 1001 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1030 (e.g., LLM/VLM/MMLM/etc.). In some embodiments, the input 1001 includes plain text in the form of one or more sentences, paragraphs, and/or documents. Additionally or alternatively, the input 1001 may include numerical sequences, precomputed embeddings (e.g., word or sentence embeddings), and/or structured data (e.g., in tabular formats, JSON, or XML). In some implementations in which the generative LM 1030 is capable of processing multi-modal inputs, the input 1001 may combine text (or may omit text) with image data, audio data, video data, design data, USD data, and/or other types of input data, such as but not limited to those described herein. Taking raw input text as an example, the input processor 1005 may prepare raw input text in various ways. For example, the input processor 1005 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1005 may remove stopwords to reduce noise and focus the generative LM 1030 on more meaningful content. The input processor 1005 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1092 (which may include one or more RAG models, and/or may be performed using the generative LM 1030 itself) may be used to retrieve additional information to be used as part of the input 1001 or prompt. RAG may be used to enhance the input to the LLM/VLM/MMLM/etc. with external knowledge, so that answers to specific questions or queries or requests are more relevant—such as in a case where specific knowledge is required. The RAG component 1092 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1001 may be generated using the query or input to the model (e.g., a question, a request, etc.) in addition to data retrieved using the RAG component 1092. In some embodiments, the input processor 1005 may analyze the input 1001 and communicate with the RAG component 1092 (or the RAG component 1092 may be part of the input processor 1005, in embodiments) in order to identify relevant text and/or other data to provide to the generative LM 1030 as additional context or sources of information from which to identify the response, answer, or output 1090, generally. For example, where the input indicates that the user is interested in a desired tire pressure for a particular make and model of vehicle, the RAG component 1092 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1092 may retrieve a prior stored conversation history—or at least a summary thereof—and include the prior conversation history along with the current ask/request as part of the input 1001 to the generative LM 1030.

The RAG component 1092 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1092 and the embeddings of the chunks along with the embeddings of the query may be compared to identify the most similar/related embeddings to the query, which may be supplied to the generative LM 1030 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may strore relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1092 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1010 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1030 to understand morphological variations and handle out-of-vocabulary words more effectively. Character-based tokenization represents each character as a separate token, enabling the generative LM 1030 to process text at a fine-grained level. The choice of tokenization strategy may depend on factors such as the language being processed, the task at hand, and/or characteristics of the training dataset. As such, the tokenizer 1010 may convert the (e.g., processed) text into a structured format according to tokenization schema being implemented in the particular embodiment.

The embedding component 1020 may use any known embedding technique to transform discrete tokens into (e.g., dense, continuous vector) representations of semantic meaning. For example, the embedding component 1020 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1001 includes image data/video data/etc., the input processor 1001 may resize the data to a standard size compatible with format of a corresponding input channel and/or may normalize pixel values to a common range (e.g., 0 to 1) to ensure a consistent representation, and the embedding component 1020 may encode the image data using any known technique (e.g., using one or more convolutional neural networks (CNNs) to extract visual features). In some implementations in which the input 1001 includes audio data, the input processor 1001 may resample an audio file to a consistent sampling rate for uniform processing, and the embedding component 1020 may use any known technique to extract and encode audio features—such as in the form of a spectrogram (e.g., a mel-spectrogram). In some implementations in which the input 1001 includes video data, the input processor 1001 may extract frames or apply resizing to extracted frames, and the embedding component 1020 may extract features such as optical flow embeddings or video embeddings and/or may encode temporal information or sequences of frames. In some implementations in which the input 1001 includes multi-modal data, the embedding component 1020 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1030 and/or other components of the generative LM system 1000 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1020 may apply an encoded representation of the input 1001 to the generative LM 1030, and the generative LM 1030 may process the encoded representation of the input 1001 to generate an output 1090, which may include responsive text and/or other types of data.

As described herein, in some embodiments, the generative LM 1030 may be configured to access or use—or capable of accessing or using—plug-ins/APIs 1095 (which may include one or more plug-ins, application programming interfaces (APIs), databases, data stores, repositories, etc.). For example, for certain tasks or operations that the generative LM 1030 is not ideally suited for, the model may have instructions (e.g., as a result of training, and/or based on instructions in a given prompt, such as those retrieved using the RAG component 1092) to access one or more plug-ins/APIs 1095 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1095 to the plug-in/API 1095, the plug-in/API 1095 may process the information and return an answer to the generative LM 1030, and the generative LM 1030 may use the response to generate the output 1090. This process may be repeated—e.g., recursively—for any number of iterations and using any number of plug-ins/APIs 1095 until an output 1090 that addresses each ask/question/request/process/operation/etc. from the input 1001 can be generated. As such, the model(s) may not only rely on its own knowledge from training on a large dataset(s) and/or from data retrieved using the RAG component 1092, but also on the expertise or optimized nature of one or more external resources—such as the plug-ins/APIs 1095.

FIG. 10B is a block diagram of an example implementation in which the generative LM 1030 includes a transformer encoder-decoder. For example, assume input text such as “Who discovered gravity” is tokenized (e.g., by the tokenizer 1010 of FIG. 10A) into tokens such as words, and each token is encoded (e.g., by the embedding component 1020 of FIG. 910A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1035 of the generative LM 1030.

In an example implementation, the encoder(s) 1035 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1040 may convert the context vector into attention vectors (keys and values) for the decoder(s) 1045.

In an example implementation, the decoder(s) 1045 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1035, in an example transformer architecture, each token (e.g., word) flows through a separate path in the decoder(s) 1045. During a first pass, the decoder(s) 1045, a classifier 1050, and a generation mechanism 1055 may generate a first token, and the generation mechanism 1055 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1045 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1035, except that it creates its queries from the layer below it and takes the keys and values (e.g., matrix) from the output of the encoder(s) 1035.

As such, the decoder(s) 1045 may output some decoded (e.g., vector) representation of the input being applied during a particular pass. The classifier 1050 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1055 may select or sample a word or token based on a corresponding predicted probability (e.g., select the word with the highest predicted probability) and append it to the output from a previous pass, generating each word or token sequentially. The generation mechanism 1055 may repeat the process, triggering successive decoder inputs and corresponding predictions until selecting or sampling a symbol or token that represents the end of the response, at which point, the generation mechanism 1055 may output the generated response.

FIG. 10C is a block diagram of an example implementation in which the generative LM 1030 includes a decoder-only transformer architecture. For example, the decoder(s) 1060 of FIG. 10C may operate similarly as the decoder(s) 1045 of FIG. 10B except each of the decoder(s) 1060 of FIG. 10C omits the encoder-decoder self-attention layer (since there is no encoder in this implementation). As such, the decoder(s) 1060 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1060. As with the decoder(s) 1045 of FIG. 10B, each token (e.g., word) may flow through a separate path in the decoder(s) 1060, and the decoder(s) 1060, a classifier 1065, and a generation mechanism 1070 may use auto-regression to sequentially generate one token at a time until predicting a symbol or token that represents the end of the response. The classifier 1065 and the generation mechanism 1070 may operate similarly as the classifier 1050 and the generation mechanism 1055 of FIG. 10B, with the generation mechanism 1070 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). As such, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)-which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that allow the computing device 1100 to communicate with other computing devices via an electronic communication network, included wired and/or wireless communications. The communication interface 1110 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may allow the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that allow detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to allow the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-1216(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1228, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may use distributed file system 1238 for large-scale data processing (e.g., “big data”). In at least one embodiment, job scheduler 1228 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1228. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

One or more of the embodiments described below may be combined with one or more other embodiments or exist alone without any combining. In an example embodiment, one or more processors comprising processing circuitry to: generate, based at least on a language model processing an input, computer programming code; automatically provide the computer programming code to a code evaluation tool responsive to the language model generating the computer programming code; generate, based at least on the code evaluation tool processing the computer programming code, feedback corresponding to the computer programming code; and responsive to the code evaluation tool generating the feedback corresponding to the computer programming code, automatically provide a prompt to the language model to update the computer programming code based at least on the input, the computer programming code, and the feedback; and generate, based at least on the language model processing the prompt, updated computer programming code that accounts for the feedback from the code evaluation tool.

In some embodiments, the processing circuitry is further to: responsive to the language model generating the updated computer programming code, automatically provide, to a second language model, the updated computer programming code and a request to perform a final evaluation of the updated computer programming code.

In some embodiments, the processing circuitry is further to: determine that the updated computer programming code does not meet a code quality threshold; and responsive to the determining that the updated computer programming code does not meet the code quality threshold, cause the language model to iteratively generate further updated computer programming code until the code quality threshold is met.

In some embodiments, the processing circuitry is further to: based at least on the code quality threshold being met, automatically provide, to a second language model, finalized computer programming code and a request to perform a final evaluation of the finalized computer programming code.

In some embodiments, the input includes at least one of: a problem statement indicative of a problem or task specified in natural language that a user wants to solve or address, a code quality template indicating how generated code should be structured, written, or behave, or a list of code evaluation tools to be used for the feedback including the code evaluation tool.

In some embodiments, the code evaluation tool includes one of: a compiler, an interpreter, a code compliance tool, a static code analyzer, a security analysis tool, a performance profiler, a memory leak detector, a dependency and vulnerability scanner, a test coverage analyzer, a code complexity analyzer, a Continuous Integration (CI) tool, a linting tool, or a second language model.

In some embodiments, the processing circuitry is further to: responsive to the language model generating the updated computer programming code, automatically provide the updated computer programming code to a second code evaluation tool, and wherein the second code evaluation tool generates second feedback corresponding to the updated computer programming code.

In some embodiments, the input is provided to the language model, the computer programming code is provided to the code evaluation tool, and the indication of the feedback is provided to the language model using a Large Language Model (LLM) agent that communicates with the language model and the code evaluation tool.

In some embodiments, the one or more processors is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models; a system incorporating one or more virtual machines (VMs); a system implemented at least partially in a data center; or a system implemented at least partially using cloud computing resources.

In an embodiment, a system comprising one or more processors to: cause a first language model to generate computer programming code based at least on user input; in response to the causing the first language model to generate the computer programming code, automatically cause a code evaluation tool to generate feedback for the computer programming code; and in response to the causing of the code evaluation tool to generate feedback for the computer programming code, automatically cause at least one of the first language model or a second language model to revise the computer programming code based at least on the user input and the feedback.

In some embodiments, the first language model outputs re-generated code based at least on a prompt, and wherein the one or more processors are further to: in response to the first language model re-generating the computer programming code based at least on the feedback, automatically provide, to the second language model, the re-generated computer programming code and a request to perform a final evaluation of the re-generated computer programming code.

In some embodiments, the first language model outputs re-generated code based at least on a prompt, and wherein the one or more processors are further to: determine that the re-generated code does not meet a code quality threshold; and in response to the determining that the re-generated code does not meet the code quality threshold, cause the first language model to re-generate code until the code quality threshold is met.

In some embodiments, the one or more processors are further to: based at least on the code quality threshold being met, automatically provide, to the second language model, finalized computer programming code and a request to perform a final evaluation of the finalized computer programming code.

In some embodiments, the user input includes at least one of: a problem statement indicative of a problem or task specified in natural language that a user wants to solved or addressed, a code quality template indicating how generated code should be structured, written, or behave, or a list of code evaluation tools to be used for the feedback including the code evaluation tool.

In some embodiments, the code evaluation tool includes one of: a compiler, an interpreter, a code compliance tool, a static code analyzer, a security analysis tool, a performance profiler, a memory leak detector, a dependency and vulnerability scanner, a test coverage analyzer, a code complexity analyzer, a Continuous Integration (CI) tool, a linting tool, or the second language model.

In some embodiments, the first language model outputs re-generated code based at least on a prompt, and wherein the one or more processors are further to: in response to the first language model generating the computer programming code, automatically provide the computer programming code to a second code evaluation tool, and wherein the second code evaluation tool generates second feedback for the computer programming code, wherein the re-generated code is based on the first feedback and the second feedback.

In some embodiments, the causing of the first language model to generate computer programming code, the causing of the first code evaluation tool to generate feedback, and the causing of least one of the first language model or the second language model to revise the computer programming code is performed by a Large Language Model (LLM) agent that communicates with the first language model and the code evaluation tool.

In some embodiments, the system includes at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs); a system implemented using one or more multi-modal language models; a system incorporating one or more virtual machines (VMs); a system implemented at least partially in a data center; or a system implemented at least partially using cloud computing resources.

In an embodiments, a method comprises: based at least on a first language model generating computer programming code, providing the computer programming code to a code evaluation tool, the code evaluation tool generating feedback for the computer programming code, and wherein the first language model is included in a first container and the code evaluation tool is outside of the first container; and based at least on the code evaluation tool generating feedback for the computer programming code, provide, to at least one of: the first language model or a second language model, a prompt to request at least one of the first language model or the second language model to modify the computer programming code based at least on the input and the feedback, and wherein the second language model is included in a second container.

In some embodiments, the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for implemented using one or more large language models (LLMs); a system for implemented using one or more vision language models (VLMs) a system implemented using one or more multi-modal language models; a system incorporating one or more virtual machines (VMs); a system implemented at least partially in a data center; or a system implemented at least partially using cloud computing resources.

What is claimed is:

1. One or more processors comprising processing circuitry to:
generate, based at least on a language model processing an input, computer programming code;
automatically provide the computer programming code to a code evaluation tool responsive to the language model generating the computer programming code;
generate, based at least on the code evaluation tool processing the computer programming code, feedback corresponding to the computer programming code; and
responsive to the code evaluation tool generating the feedback corresponding to the computer programming code, automatically provide a prompt to the language model to update the computer programming code based at least on the input, the computer programming code, and the feedback; and
generate, based at least on the language model processing the prompt, updated computer programming code that accounts for the feedback from the code evaluation tool.

2. The one or more processors of claim 1, wherein the processing circuitry is further to:
responsive to the language model generating the updated computer programming code, automatically provide, to a second language model, the updated computer programming code and a request to perform a final evaluation of the updated computer programming code.

3. The one or more processors of claim 1, wherein the processing circuitry is further to:
determine that the updated computer programming code does not meet a code quality threshold; and
responsive to the determining that the updated computer programming code does not meet the code quality threshold, cause the language model to iteratively generate further updated computer programming code until the code quality threshold is met.

4. The one or more processors of claim 3, wherein the processing circuitry is further to:
based at least on the code quality threshold being met, automatically provide, to a second language model, finalized computer programming code and a request to perform a final evaluation of the finalized computer programming code.

5. The one or more processors of claim 1, wherein the input includes at least one of: a problem statement indicative of a problem or task specified in natural language that a user wants to solve or address, a code quality template indicating how generated code should be structured, written, or behave, or a list of code evaluation tools to be used for the feedback including the code evaluation tool.

6. The one or more processors of claim 1, wherein the code evaluation tool includes one of: a compiler, an interpreter, a code compliance tool, a static code analyzer, a security analysis tool, a performance profiler, a memory leak detector, a dependency and vulnerability scanner, a test coverage analyzer, a code complexity analyzer, a Continuous Integration (CI) tool, a linting tool, or a second language model.

7. The one or more processors of claim 1, wherein the processing circuitry is further to:
responsive to the language model generating the updated computer programming code, automatically provide the updated computer programming code to a second code evaluation tool, and wherein the second code evaluation tool generates second feedback corresponding to the updated computer programming code.

8. The one or more processors of claim 1, wherein the input is provided to the language model, the computer programming code is provided to the code evaluation tool, and the indication of the feedback is provided to the language model using a Large Language Model (LLM) agent that communicates with the language model and the code evaluation tool.

9. The one or more processors of claim 1, wherein the one or more processors is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs);
a system implemented using one or more multi-modal language models;
a system incorporating one or more virtual machines (VMs);
a system implemented at least partially in a data center; or
a system implemented at least partially using cloud computing resources.

10. A system comprising one or more processors to:
cause a first language model to generate computer programming code based at least on user input;
in response to the causing the first language model to generate the computer programming code, automatically cause a code evaluation tool to generate feedback for the computer programming code; and
in response to the causing of the code evaluation tool to generate feedback for the computer programming code, automatically cause at least one of the first language model or a second language model to revise the computer programming code based at least on the user input and the feedback.

11. The system of claim 10, wherein the first language model outputs re-generated code based at least on a prompt, and wherein the one or more processors are further to:
in response to the first language model re-generating the computer programming code based at least on the feedback, automatically provide, to the second language model, the re-generated computer programming code and a request to perform a final evaluation of the re-generated computer programming code.

12. The system of claim 10, wherein the first language model outputs re-generated code based at least on a prompt, and wherein the one or more processors are further to:
determine that the re-generated code does not meet a code quality threshold; and
in response to the determining that the re-generated code does not meet the code quality threshold, cause the first language model to re-generate code until the code quality threshold is met.

13. The system of claim 12, wherein the one or more processors are further to:
based at least on the code quality threshold being met, automatically provide, to the second language model, finalized computer programming code and a request to perform a final evaluation of the finalized computer programming code.

14. The system of claim 10, wherein the user input includes at least one of: a problem statement indicative of a problem or task specified in natural language that a user wants to solved or addressed, a code quality template indicating how generated code should be structured, written, or behave, or a list of code evaluation tools to be used for the feedback including the code evaluation tool.

15. The system of claim 10, wherein the code evaluation tool includes one of: a compiler, an interpreter, a code compliance tool, a static code analyzer, a security analysis tool, a performance profiler, a memory leak detector, a dependency and vulnerability scanner, a test coverage analyzer, a code complexity analyzer, a Continuous Integration (CI) tool, a linting tool, or the second language model.

16. The system of claim 10, wherein the first language model outputs re-generated code based at least on a prompt, and wherein the one or more processors are further to:
in response to the first language model generating the computer programming code, automatically provide the computer programming code to a second code evaluation tool, and wherein the second code evaluation tool generates second feedback for the computer programming code, wherein the re-generated code is based on the first feedback and the second feedback.

17. The system of claim 10, wherein the causing of the first language model to generate computer programming code, the causing of the first code evaluation tool to generate feedback, and the causing of least one of the first language model or the second language model to revise the computer programming code is performed by a Large Language Model (LLM) agent that communicates with the first language model and the code evaluation tool.

18. The system of claim 11, wherein the system includes at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs);
a system implemented using one or more multi-modal language models;
a system incorporating one or more virtual machines (VMs);
a system implemented at least partially in a data center; or
a system implemented at least partially using cloud computing resources.

19. A method comprising:
based at least on a first language model generating computer programming code, providing the computer programming code to a code evaluation tool, the code evaluation tool generating feedback for the computer programming code, and wherein the first language model is included in a first container and the code evaluation tool is outside of the first container; and
based at least on the code evaluation tool generating feedback for the computer programming code, provide, to at least one of: the first language model or a second language model, a prompt to request at least one of the first language model or the second language model to modify the computer programming code based at least on the input and the feedback, and wherein the second language model is included in a second container.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for implemented using one or more large language models (LLMs);
a system for implemented using one or more vision language models (VLMs) a system implemented using one or more multi-modal language models;
a system incorporating one or more virtual machines (VMs);
a system implemented at least partially in a data center; or
a system implemented at least partially using cloud computing resources.
